(19) United States
(12) Patent Application Publication
(10) Pub. No.: US 2026/0289149 A1
(43) Pub. Date: Sep. 24, 2026

(54) SYSTEM

(71) Applicant: SoftBank Group Corp., Tokyo (JP)

(72) Inventor: Takayuki OZAKI, Tokyo (JP)

(73) Assignee: SoftBank Group Corp., Tokyo (JP)

(21) Appl. No.: 19/568,822

(22) Filed: Mar. 17, 2026

(30) Foreign Application Priority Data
Mar. 19, 2025 (JP) 2025-045161

(51) Int. Cl. G06F 40/35

(52) U.S. Cl. CPC G06F 40/35

(57) ABSTRACT

A system includes a processor that is configured to provide an interactive interface for collecting feedback and requests from a user, analyze collected feedback and requests using natural language processing techniques and a generative AI model to extract sentiment, and generate a prompt for instructing the generative AI model to automatically propose optimal improvement measures and actions based on an analysis result and the extracted sentiment.

### CROSS-REFERENCE TO RELATED APPLICATION

This application is based on and claims priority under 35 USC 119 from Japanese Patent Application No. 2025-045161 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for collecting and utilizing customer feedback often rely on manual analysis and ad hoc interpretation of free-form text, which leads to slow response times, inconsistent quality of analysis, and difficulty in extracting actionable insights such as customer sentiment and concrete improvement measures. Even when natural language processing techniques are used, many existing systems merely classify or summarize feedback and do not effectively convert the analysis results and extracted sentiment into specific proposals for improvement or marketing strategies.

Further, in typical workflows, the design and input of prompts for generative AI models depend heavily on human expertise. As a result, the consistency and reliability of the output from the generative AI models vary widely, and it is difficult to systematically and automatically derive optimal improvement measures and marketing strategies from large volumes of feedback. Consequently, there is a need for a system that can automatically collect user feedback through an interactive interface, accurately analyze the content and sentiment using natural language processing and a generative AI model, and autonomously generate appropriate prompts to instruct the generative AI model to propose optimal improvement measures and marketing strategies in a form that can be readily understood and utilized by the user.

### SUMMARY

In order to solve the above-described problems, the present invention provides a system comprising a processor, wherein the processor is configured to provide an interactive interface for collecting feedback and requests from a user, analyze collected feedback and requests using natural language processing techniques and a generative AI model to extract sentiment, and generate a prompt for instructing the generative AI model to automatically propose optimal improvement measures and actions based on an analysis result and the extracted sentiment. The processor is further configured to use the prompt to appropriately guide the generative AI model to automatically determine related marketing strategies from contents of the analyzed feedback and requests. In addition, the processor is configured to generate a prompt for instructing the generative AI model to automatically generate optimal marketing strategies based on the analysis result and the extracted sentiment and to present the generated marketing strategies to the user visually in a dashboard format. By automating both the analysis of feedback and the generation of prompts to the generative AI model, the system enables consistent, efficient, and scalable derivation of improvement measures and marketing strategies from large volumes of user feedback.

The term “system” refers to an integrated combination of hardware and software components including at least one processor and associated memory, interfaces, and executable programs configured to perform the claimed functions.

The term “processor” refers to one or more hardware processing units, such as a central processing unit (CPU), graphics processing unit (GPU), or specialized accelerator, that execute machine-readable instructions to perform the operations specified in the claims.

The term “interactive interface” refers to a user-facing input/output mechanism, such as a web page, mobile application screen, or graphical user interface, that enables a user to enter feedback or requests and to receive information or results from the system in real time or near real time.

The term “feedback and requests” refers to information, opinions, evaluations, complaints, suggestions, demands, or other free-form or structured input that a user provides to the system regarding products, services, marketing activities, or related topics.

The term “natural language processing techniques” refers to algorithms, models, or procedures that analyze, interpret, or transform text expressed in human language, including but not limited to tokenization, parsing, classification, sentiment analysis, entity extraction, and semantic analysis.

The term “generative AI model” refers to a machine learning model, such as a large language model or other generative model, that is trained on data to generate text or other content in response to input data or prompts.

The term “sentiment” refers to an evaluation or emotional state derived from text, such as positive, negative, neutral, or a graded or multidimensional representation of a user's attitude or feeling expressed in the feedback or requests.

The term “analysis result” refers to structured information obtained from processing the collected feedback and requests using natural language processing techniques and, optionally, the generative AI model, including classifications, extracted features, sentiment values, or summarized content.

The term “prompt” refers to a machine-readable instruction, query, or input text sequence that is provided to the generative AI model in order to specify a task, constrain the output, or guide the behavior of the generative AI model.

The term “improvement measures and actions” refers to recommended operational, product, service, or process changes that are proposed based on the analysis of user feedback and sentiment, and that are intended to address issues, enhance performance, or increase user satisfaction.

The term “marketing strategies” refers to plans, tactics, or policies concerning promotion, pricing, product positioning, customer targeting, communication, or campaign design that are derived from the analysis of feedback and sentiment.

The term “automatically propose” refers to causing the system, without requiring manual editing of individual outputs, to generate candidate improvement measures, actions, or marketing strategies based on the analysis result and extracted sentiment.

The term “guide the generative AI model” refers to controlling or influencing the operation of the generative AI model, such as by specifying a task, constraints, style, or output format via the prompt, so that the model produces outputs aligned with desired objectives.

The term “dashboard format” refers to a graphical presentation style in which multiple items of information, such as metrics, charts, summaries, or lists of strategies, are displayed in an organized layout on a screen or interface to allow a user to visually comprehend the generated marketing strategies.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

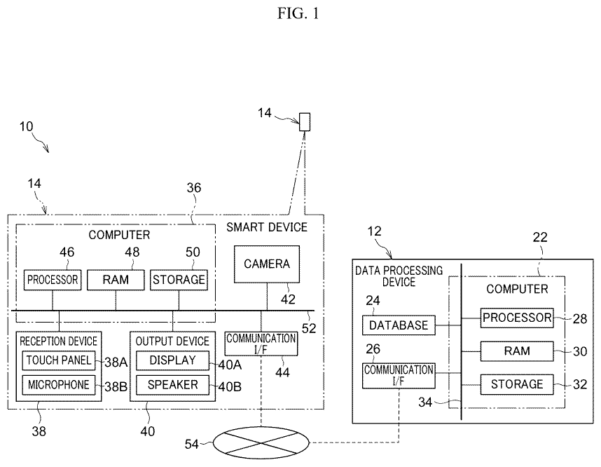

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

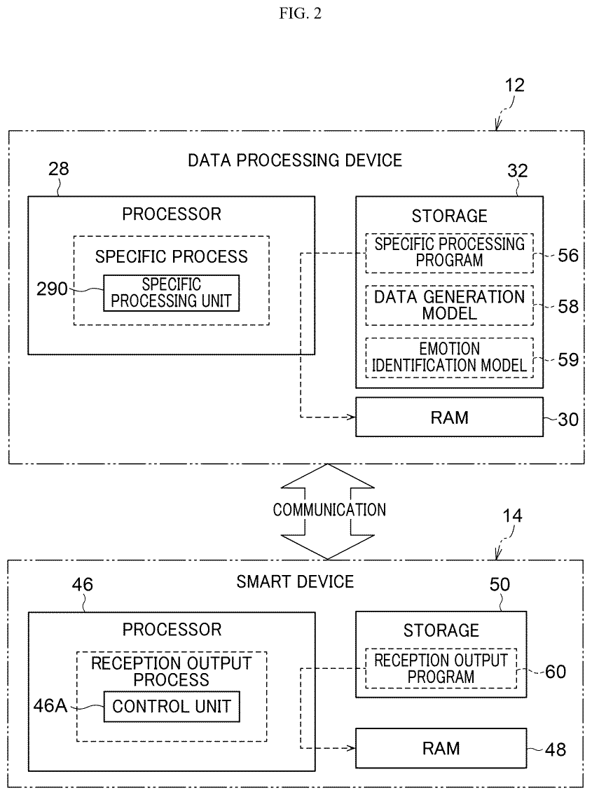

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional feedback collection and analysis systems typically treat customer opinions as unstructured text that is manually reviewed or processed with simple keyword counting or rule-based scripts. In such systems, user interfaces for feedback input are often hard-coded, storage of the feedback is not tightly integrated with downstream analytical processing, and generative artificial intelligence models, if used at all, are invoked in an ad hoc manner with manually written prompts. As a result, the quality and consistency of the prompts provided to a generative AI model strongly depend on human operators, leading to unstable proposal quality, limited reproducibility, and a high operational burden.

Furthermore, in known systems, the data path from feedback input at a terminal device to the generation and presentation of improvement proposals is fragmented across separate components. Typically, the interface layer, the data storage layer, and the AI invocation layer are loosely coupled, and there is no standardized mechanism to transform raw feedback into structured data, perform natural language preprocessing, derive representative examples, and synthesize this information into machine-optimized prompt sentences. This fragmented design causes latency, increases implementation complexity, and makes it difficult to scale the system to large volumes of feedback or to adapt it to different business domains.

From a computing technology perspective, conventional systems do not fully leverage relational data structures, query languages, and structured prompt generation pipelines to optimize the interaction between stored feedback data and generative AI models. Feedback is often stored as opaque text blobs, which hinders efficient retrieval, grouping, and aggregation using database query operations. As a result, computing resources are wasted on repeatedly processing similar input texts, and the generative AI model is not systematically guided by well-formed, data-derived prompts, leading to suboptimal utilization of AI inference capabilities.

Additionally, existing approaches for surfacing AI-generated results to users often provide only free-form text outputs that are not integrated into a structured visualization framework. This makes it difficult for users to compare different proposals, evaluate priorities, or connect AI-generated recommendations back to the underlying feedback data. In other words, the human-computer interface layer is not technically optimized to present AI-driven analytics as actionable and traceable information objects linked to stored data records.

Accordingly, there is a need for an improved computer-implemented system that: (i) programmatically generates interactive feedback interfaces using standard description and control languages, (ii) structures and stores user feedback in a relational data structure suitable for efficient querying and preprocessing, (iii) automatically constructs prompt sentences for a generative AI model based on analysis results, extracted features, and representative examples, and (iv) post-processes and visualizes AI-generated proposal information in a structured, dashboard-style format. Such a system should improve the overall computing workflow by tightly integrating user interface generation, data management, natural language processing, and generative AI invocation, thereby enhancing consistency, scalability, and technical efficiency.

The specific processing by the specific processing unit 290 of the data processing device 12 in Example 1 is realized by the following means.

The present invention provides a server comprising a processor configured to generate, using a markup language and a control language, an interactive display screen for receiving opinions and selection information from a user, to transmit the interactive display screen to a terminal device, to receive text information and selection information input on the interactive display screen from the terminal device by event detection processing, to structure the received text information and selection information and store the structured information in a relational data structure in a storage device by control using a query language, to execute natural language processing on the stored text information including preprocessing, aggregation processing, and feature extraction processing, to generate a prompt sentence by combining generation conditions including a summary of an analysis result obtained by the natural language processing, extraction of representative examples, and specification of an output format, to transmit inquiry data including the prompt sentence to a generative information processing model, to acquire proposal information in a natural language output as a response from the generative information processing model, to perform post-processing on the proposal information to convert the proposal information into a predetermined structure associated with the relational data structure, and to generate display control information for presenting the proposal information as an improvement plan or a measure plan in a list screen and a chart screen on the terminal device. This enables integrated and technically efficient computer processing from interactive feedback collection through structured storage, prompt sentence generation for a generative AI model, and structured visualization of AI-generated proposals, thereby improving the stability, reproducibility, and scalability of feedback-driven analysis and recommendation workflows in a computing environment.

The term “processor” refers to one or more hardware-based information processing units, such as a central processing unit or a combination of processing circuits, that execute instructions to perform the functions described in the system.

The term “interactive display screen” refers to a graphical user interface presented on a display device that accepts user input and provides responsive output, including forms, buttons, and other controls enabling bidirectional interaction between a user and the system.

The term “markup language” refers to a description language used to define the structure and presentation of content in the interactive display screen, including, for example, a language that represents elements such as text fields, labels, and input controls.

The term “control language” refers to a programmatic or scripting language executed in association with the interactive display screen to control user interactions, event handling, communication with a server, and dynamic modification of displayed content.

The term “terminal device” refers to an information processing apparatus operated by a user, such as a client computer, mobile device, or other computing terminal, that displays the interactive display screen and transmits user input to the server.

The term “opinion” refers to free-form textual content entered by a user to express feedback, evaluation, or a request regarding a product, service, or subject matter presented on the interactive display screen.

The term “selection information” refers to data representing choices made by a user through selectable elements on the interactive display screen, including checkbox selections, radio button selections, menu choices, or similar structured selections.

The term “event detection processing” refers to processing that monitors and responds to user interaction events, such as clicking, typing, or submitting a form, and triggers acquisition and transmission of input data when such events occur.

The term “communication path” refers to one or more logical or physical channels, including wired or wireless networks, used to transmit data between the terminal device and the server.

The term “text information” refers to character-based data obtained from user input fields, including strings of letters, numbers, or symbols that represent feedback or related content.

The term “relational data structure” refers to a data organization format based on relations composed of tuples and attributes, typically implemented as one or more tables in a relational database system.

The term “storage device” refers to a non-transitory computer-readable medium, such as a magnetic storage, solid-state storage, or other persistent memory, used to store program instructions and data structures including the relational data structure.

The term “query language” refers to a formal language used to specify retrieval, insertion, updating, and deletion operations on the relational data structure, including statements that define conditions and operations for manipulating stored data.

The term “natural language processing” refers to computerized analysis and transformation of human language text, including operations such as tokenization, normalization, aggregation, feature extraction, and other linguistic or statistical processing.

The term “preprocessing” refers to initial natural language processing operations applied to text information to prepare it for subsequent analysis, including cleaning, normalization, segmentation, and format conversion.

The term “aggregation processing” refers to processing that combines multiple pieces of text information or selection information into summarized or grouped forms based on criteria such as topic, category, or statistical properties.

The term “feature extraction processing” refers to processing that derives representative attributes or indicators from text information, including, for example, keywords, topics, sentiment scores, or other numerical or symbolic features.

The term “analysis result” refers to data obtained from natural language processing applied to text information, including summaries, classifications, extracted features, or other interpreted representations of the original feedback.

The term “generation conditions” refers to parameters and constraints used to control content generation by a generative information processing model, including at least a summary of analysis results, representative examples, and an output format specification.

The term “prompt sentence” refers to one or more text strings supplied to a generative information processing model as input instructions and context, constructed from generation conditions to guide the model's output.

The term “inquiry data” refers to a data set transmitted to the generative information processing model, including at least the prompt sentence and optionally additional metadata or parameters that influence model behavior.

The term “generative information processing model” refers to a computational model that receives text-based input and automatically generates natural language or other content based on learned statistical relationships, including but not limited to a generative AI model.

The term “proposal information” refers to natural language content output from the generative information processing model that includes suggested improvement plans, measure plans, or other recommendations derived from the prompt sentence and underlying feedback data.

The term “post-processing” refers to processing applied to the proposal information after it is generated by the generative information processing model, including restructuring, formatting, extracting elements, and converting the information into a predetermined data structure.

The term “predetermined structure” refers to a defined data format used to store proposal information, including fields, attributes, and relationships that enable association with the relational data structure and subsequent retrieval and display.

The term “improvement plan” refers to a structured representation of recommended actions for modifying or enhancing a product, service, or process based on analyzed feedback and generated proposal information.

The term “measure plan” refers to a structured representation of recommended operational or strategic actions, such as marketing, sales, or service measures, derived from analyzed feedback and generated proposal information.

The term “display control information” refers to data and instructions generated by the processor to control how proposal information, index values, category information, and explanatory texts are arranged and presented on a display device.

The term “list screen” refers to a graphical presentation format in which multiple items of information, such as proposals or summaries, are displayed as a list for user browsing and selection.

The term “chart screen” refers to a graphical presentation format that visualizes data, such as index values or categories, using diagrams including graphs, charts, or similar visual elements.

The term “dashboard format” refers to a composite graphical user interface that concurrently presents multiple visual components, including list screens and chart screens, to provide an overview and detailed view of proposal information and related indicators.

The term “index value” refers to a numerical or symbolic indicator computed from feedback data or proposal information, used to represent metrics such as priority, frequency, or impact.

The term “category information” refers to data representing a classification or grouping of feedback or proposal information, such as topic categories, segments, or labels used for organizing and filtering information.

The term “explanatory text” refers to natural language text that describes or explains proposal information, index values, or category information in a form understandable to a human user.

In one embodiment, a server implements the claimed system by executing program instructions stored in a non-transitory computer-readable medium on one or more processors.

The server is connected to one or more terminal devices via a communication network such as the Internet or a local area network. The server includes a processor, a main memory, a storage device implementing a relational database, and a network interface controller. The terminal includes a processor, a memory, a display device, an input device, and a network interface. The user operates the terminal to access an interactive display screen provided by the server.

The server uses a markup language, such as a hypertext description language, and a control language, such as a client-side scripting language, to generate the interactive display screen. The interactive display screen includes input components such as text fields, text areas, check boxes, radio buttons, and submission buttons. The server embeds control language code that registers event listeners on these input components and specifies endpoints on the server to which data are transmitted. The server transmits the generated markup and control language code to the terminal through the network interface using a hypertext transfer protocol.

The terminal receives the markup and control language code, stores them in the terminal memory, and executes the control language using a script engine implemented in a web browser application. The terminal renders the interactive display screen on the display device.

The user views the display screen and inputs free-form opinions and selection information, such as checking options or selecting items from a list. The terminal detects user interactions by event detection processing; for example, the terminal detects a “submit” event when the user activates a submission control.

The terminal, in response to the event detection, acquires text information and selection information from the input components, constructs structured data such as key-value pairs, and transmits the data to the server through the communication path. The terminal may also add metadata, such as a timestamp or device type, before transmission. This event-driven acquisition and transmission reduces unnecessary polling traffic, thereby reducing communication load and improving power efficiency on the terminal and the server.

The server receives the text information and selection information via an application programming interface endpoint implemented by a server application. The server parses the received data and validates field formats, using rule-based checks such as length constraints, character set validation, and enumeration validation for selection fields. The server structures the validated data into tuples conforming to a predefined relational schema. The server stores these tuples in tables of a relational database executed by a database management system, such as a generic relational database engine, via a query language interface. The relational schema includes tables for raw feedback records, user identifiers, question configurations, and generated proposal information, where each table is linked by foreign keys.

The server uses this relational data structure to perform efficient retrieval and aggregation. By defining indexes on columns such as question identifiers, creation timestamps, and extracted feature values, the server accelerates query processing and reduces I/O overhead. The server uses the query language to retrieve sets of text information and associated selection information conditioned on various criteria, such as time ranges, product identifiers, or sentiment categories.

The server executes natural language processing on the stored text information. The server loads text information from the database into the main memory and performs preprocessing operations, including tokenization, lowercasing, removal of stop words, and normalization of character encodings. The server may use statistical or rule-based tokenizers, part-of-speech taggers, and sentence segmenters implemented in a natural language processing library. The server performs aggregation processing by grouping feedback entries with similar attributes, for example grouping by question identifier or by extracted topics. The server may compute numerical feature vectors representing each text segment using methods such as term frequency-inverse document frequency or word embedding projections, and may perform clustering to identify representative feedback examples within each group.

The server performs feature extraction processing to derive technical features such as sentiment scores, topic distributions, key phrases, and intensity measures. The server may compute sentiment scores using a classifier trained on labeled text that outputs probabilities for categories such as positive, neutral, and negative. The server may extract topics using a probabilistic topic model or by mapping text to a low-dimensional embedding space generated by a pre-trained neural network, and then applying similarity metrics. These feature values are stored in additional columns in the relational database. This design improves data management by enabling efficient indexing, filtering, and joining based on derived features, thereby reducing the computational cost of repeatedly performing full-text analysis.

The server constructs generation conditions for a generative AI model by combining analysis results and feature values. For each group of feedback entries, the server selects representative examples based on criteria such as highest sentiment intensity, centrality in an embedding cluster, or frequency of occurrence of specific key phrases. The server summarizes the analysis result for the group, for example by computing the distribution of sentiment categories, listing dominant topics, and identifying frequently mentioned attributes.

The server defines an output format specification that indicates desired structure of the generative AI model output, such as a list of bullet points, prioritized recommendations, and associated rationales.

The server generates a prompt sentence by concatenating fixed instruction text with the dynamically computed summaries, representative examples, and output format specification.

In one example, the server generates a prompt sentence of the following form:
“You are an expert assistant that proposes concrete improvement actions based on user feedback.
Question: ‘Please tell us your opinion about the design of the new product.’
Representative feedback examples:
1. ‘I want more color variations.’
2. ‘The shape is good, but the colors are boring.’
Analysis summary: Most users mention insufficient color options and moderate satisfaction with the shape.
Task: Based on the above analysis and examples, propose three specific and actionable improvement plans for the product design team.
Output format:
Summarize key issues in 3 bullet points.
Propose 3 improvement actions, each with a brief explanation.”

In another example, the server generates a prompt sentence oriented toward strategy design:
“You are a strategic planning assistant.

Here are aggregated user comments about our new service interface. Most comments report confusion about navigation labels and request clearer instructions, while overall satisfaction with performance is high.

Based on these observations, propose:
(1) key usability issues in no more than 5 bullet points, and
(2) 3 prioritized interface improvement measures that can be implemented within one release cycle.”

The server supplies the prompt sentence, together with metadata such as desired maximum token count and temperature parameters, as part of inquiry data to a generative AI model. In one embodiment, the generative AI model is realized by a neural network language model deployed on a remote computing service. The model comprises multiple transformer layers, each including a multi-head self-attention mechanism and position-wise feed-forward networks. The model uses learned weight matrices to compute contextual token representations and to generate output tokens by sampling from a probability distribution over a vocabulary.

The server interfaces with the generative AI model through an application programming interface over a secure communication channel. The server sends a sequence of tokens representing the prompt sentence to the model. The model computes attention weights across the sequence, propagates intermediate representations through the transformer layers, and generates output tokens one by one according to a decoding strategy, such as greedy decoding or sampling with temperature. The server receives the sequence of output tokens, decodes them into natural language proposal information, and stores the complete generated text in the storage device.

The server may locally or remotely perform training or fine-tuning of the generative AI model. For training, the server prepares a training dataset consisting of input sequences and target output sequences, where input sequences include past feedback summaries and example comments, and output sequences include high-quality human-authored improvement proposals. The server defines a loss function such as cross-entropy between the predicted token distribution and the target token distribution. The server updates the neural network weights by backpropagation using stochastic gradient descent or a variant such as Adam. The server may apply data augmentation methods such as paraphrasing feedback texts, injecting controlled noise, or balancing class distributions across sentiment categories. These training operations improve the model's capability to produce accurate and contextually appropriate proposals across diverse feedback distributions.

The server executes post-processing on the proposal information generated by the generative AI model. The server parses the natural language output according to the requested output format. For example, the server identifies bullet points, headings, and numbered lists by detecting delimiters and lexical patterns. The server extracts individual improvement items, priority indicators, and any explicit constraints or dependencies mentioned in the text. The server converts this information into a predetermined structured format, such as a set of records with fields for problem description, recommended action, priority level, and related feature identifiers.

The server stores the structured proposal information in a proposal table in the relational database and associates each proposal record with the originating feedback group, question identifier, and analysis result identifier via foreign keys. This association enables traceability from an individual proposal back to the underlying raw feedback and computed features, which improves auditing and debugging of the generative AI model behavior. It also allows the server to avoid redundant processing by detecting when similar feedback patterns have already been analyzed and proposals have been generated.

The server generates display control information for presenting the proposal information to the user. The server retrieves proposal records and associated analytic metrics from the relational database using query language statements. The server computes index values such as aggregated priority scores, frequency counts of issues, coverage ratios of proposals across feedback segments, and confidence scores derived from model output statistics or feature distributions. The server groups proposal records into categories based on topics, affected components, or user segments and creates category information for display.

The server arranges these elements into a logical screen structure comprising a list screen and a chart screen. The list screen includes rows with textual proposals, associated index values, and category labels. The chart screen includes visual elements such as bar charts, pie charts, or trend lines showing distributions of issues and priorities. The server serializes this screen structure and associated styling data into markup and control language code, thereby generating display control information, and transmits the display control information to the terminal.

The terminal receives the display control information, interprets the markup and control language code, and renders the dashboard format on the display device. The user can interact with the dashboard by filtering proposals by category, sorting by index values, or expanding and collapsing detailed explanations. When the user manipulates controls on the dashboard, the terminal performs event detection processing and triggers additional queries to the server as needed, such as requesting drill-down views of the underlying raw feedback for a specific proposal.

This architecture produces technical effects that extend beyond mere automation of human mental processes. By structuring feedback and proposal information in a relational data structure with indexed feature columns, the server reduces the time complexity of retrieval and aggregation operations, thereby improving processing speed. By performing natural language preprocessing and feature extraction prior to prompt generation, the server reduces the input length and redundancy provided to the generative AI model, which decreases inference time and network bandwidth usage between the server and the model host, improving communication efficiency.

By constructing prompt sentences using analysis results, representative examples, and standardized output specifications, the server stabilizes the quality and structure of generated outputs and reduces variance relative to ad hoc manually created prompts. This controlled prompt generation improves accuracy and reduces error in the proposals, as the generative AI model is guided by more informative and less noisy inputs. Additionally, by storing analysis results, prompt templates, and proposal outputs in a unified relational schema, the server avoids repetitive full-text processing and redundant AI calls for similar feedback patterns, thereby improving overall computational efficiency and reducing server load.

The system improves computer technology by integrating user interface generation, relational data management, statistical natural language processing, and transformer-based generative modeling into a coordinated pipeline with specific data structures and control flows. The use of feature-driven prompt generation and structured post-processing of model outputs provides a non-conventional and non-generic implementation that modifies the functioning of the computer system itself. In particular, the system enables the server to allocate resources adaptively, for instance by prioritizing batches of feedback that exhibit high sentiment intensity or novelty in feature space, which further reduces processing latency and enhances scalability.

In alternative embodiments, the server deploys different variants of the generative AI model, such as models with different numbers of attention heads or layers, or models fine-tuned for particular domains. The server may dynamically select a model variant based on feedback characteristics, such as language, domain category, or required response length, as determined from the extracted features. The server may also use different natural language processing pipelines, such as rule-based segmentation for certain languages and neural segmentation for others, depending on system configuration or resource constraints.

In another embodiment, the terminal is a mobile device and the server offloads certain preprocessing tasks to the terminal. For example, the terminal may perform initial tokenization or local compression of text before transmission, reducing network traffic and latency. In still another embodiment, a distributed cluster of servers shares the workload of natural language processing and generative AI invocation, with a front-end server orchestrating query routing and data synchronization among backend database nodes and model inference nodes.

In all embodiments, the server, the terminal, and the user cooperate through the described hardware and software components to implement the claimed system, such that a person skilled in the art can realize the invention by configuring standard computing equipment and software frameworks according to the structures and operations described above.

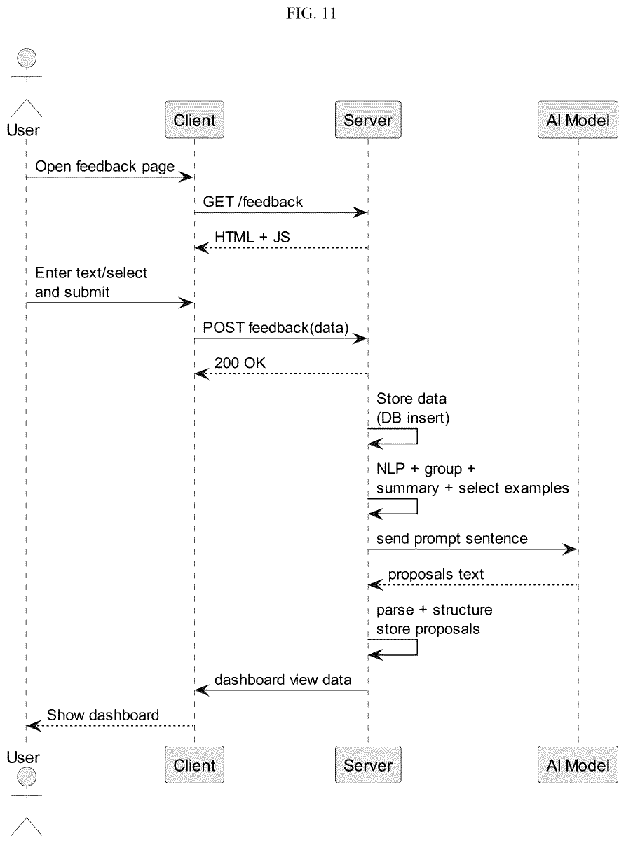

The following describes the processing flow using FIG. 11.

### Step 1

The server generates an interactive display screen and sends it to the terminal.
The server takes as input configuration data stored in a relational database, including question texts, option definitions, and display parameters. The server processes this input by embedding the configuration data into markup language structures (for example, form tags and input tags) and by inserting control language code that defines event handlers and network request targets. The server outputs a markup document and associated control scripts that describe a feedback input form.

### Step 2

The terminal renders the interactive display screen for the user.
The terminal takes as input the markup document and control scripts received from the server. The terminal processes this input by parsing the markup, constructing a visual layout in a browser engine, and executing the control scripts to attach event listeners to interactive elements. The terminal outputs a visible screen on the display device that allows the user to enter text opinions and to select options such as check boxes or radio buttons.

### Step 3

The user inputs feedback data on the interactive display screen.
The user takes as input the displayed questions and selectable options. The user processes this information mentally and operates the input devices to type textual opinions and to select one or more options that reflect the user's evaluation. The user outputs concrete input data, including text information and selection information, into the input components rendered on the terminal.

### Step 4

The terminal detects an input event and packages feedback data.
The terminal takes as input the state of the interactive elements and the occurrence of an event such as activation of a submit button. The terminal processes this input by reading the current values of text fields and selection controls, assembling them into a structured representation that includes keys, values, timestamps, and optionally device metadata. The terminal outputs a data object representing one feedback record that is ready for transmission to the server over the network.

### Step 5

The terminal transmits the structured feedback record to the server.
The terminal takes as input the structured feedback record and the address of a server endpoint defined by the control scripts. The terminal processes this input by serializing the record into a transmittable format, establishing a network connection, and attaching protocol headers required for the request. The terminal outputs a network message that carries the text information, selection information, and metadata to the server via a communication path.

### Step 6

The server receives the feedback record and validates field values.
The server takes as input the network message containing the structured feedback record from the terminal. The server processes this input by parsing the message body, extracting individual fields such as question identifier, text content, and selected options, and applying validation rules such as length checks, character set checks, and membership checks against predefined option sets. The server outputs a normalized and validated feedback record or an error status if validation fails.

### Step 7

The server stores the validated feedback record in a relational data structure.
The server takes as input the validated feedback record and the definition of a relational schema that specifies table names and column types. The server processes this input by mapping each field of the feedback record to corresponding columns and constructing a database insertion command using a query language. The server executes the command against a database engine and outputs a stored tuple in a feedback table, associated with unique identifiers and timestamps.

### Step 8

The server retrieves unprocessed feedback records for analysis.
The server takes as input status markers stored in the relational data structure that indicate which feedback records have not yet been processed by natural language processing and the generative AI model. The server processes this input by issuing query language commands that select subsets of records based on status, time range, and other constraints. The server outputs a batch of feedback records loaded into working memory as a collection of text information and associated selection information.

### Step 9

The server performs natural language preprocessing on the text information.
The server takes as input the batch of text fields from the retrieved feedback records. The server processes this input by applying linguistic operations such as tokenization, normalization, stop-word removal, and sentence segmentation using preconfigured algorithms or language models. The server may convert characters to a uniform case and unify punctuation marks. The server outputs cleaned and segmented text sequences that are suitable for downstream feature extraction and aggregation.

### Step 10

The server extracts linguistic and statistical features from the preprocessed text.
The server takes as input the cleaned text sequences obtained from preprocessing. The server processes this input by computing features such as term frequency counts, inverse document frequency values, sentiment scores, and topic-representative embeddings. The server may apply a sentiment classifier to assign probability distributions over sentiment labels and may project texts into a vector space using a neural embedding model. The server outputs numerical and categorical feature vectors associated with each feedback record.

### Step 11

The server aggregates feedback records into analytical groups.
The server takes as input the feature vectors and associated identifiers for each feedback record. The server processes this input by applying grouping operations based on attributes such as question identifier, topic cluster, or sentiment category. The server may use clustering algorithms over embedding vectors or simple grouping by shared keys. The server outputs a set of groups, where each group contains a list of feedback records and aggregated statistics such as counts, mean sentiment scores, and dominant terms.

### Step 12

The server selects representative examples within each feedback group.
The server takes as input the grouped feedback records and their feature vectors. The server processes this input by computing selection criteria, for example by finding feedback records whose feature vectors are closest to the group centroid or whose sentiment scores are at extreme values. The server ranks candidates according to these criteria and selects a subset as representative examples. The server outputs, for each group, a limited number of feedback texts that best typify the group's characteristics.

### Step 13

The server summarizes analysis results for each feedback group.
The server takes as input the aggregated statistics and representative examples for each group. The server processes this input by generating compact textual summaries that describe key issues, sentiment distributions, and frequently mentioned aspects. The server may use template-based generation, for example constructing sentences that state the proportion of positive versus negative comments and highlight recurring keywords. The server outputs an analysis summary string for each group that can be incorporated into a prompt sentence.

### Step 14

The server constructs generation conditions and a prompt sentence for a generative AI model.
The server takes as input the analysis summaries, representative examples, and desired output specifications supplied by configuration data or user preferences. The server processes this input by concatenating instruction text, group-specific summaries, and enumerated example feedback into a coherent instruction block, and by appending explicit directions on output structure, such as numbers of bullet points and types of recommendations requested. The server outputs a prompt sentence that encodes both the context and the requested form of the generative AI model output.

### Step 15

The server transmits inquiry data including the prompt sentence to the generative AI model.
The server takes as input the constructed prompt sentence and model parameters such as maximum output length and decoding temperature. The server processes this input by encoding the prompt sentence into tokens required by the model, organizing the tokens and parameters into a request message format, and sending the message through a secure communication channel to a model-serving endpoint. The server outputs an inference request that triggers execution of the generative AI model on the remote or local compute resource.

### Step 16

The server receives generated proposal information from the generative AI model.
The server takes as input the response message from the generative AI model, including sequences of generated tokens. The server processes this input by decoding tokens into human-readable text and associating the generated text with the original feedback group identifier and prompt identifier. The server outputs natural language proposal information that contains recommended improvement plans or measure plans derived from the input prompt sentence.

### Step 17

The server performs post-processing to structure the proposal information.
The server takes as input the raw generated text from the generative AI model. The server processes this input by analyzing the text format, detecting bullet points, numbering, headings, and explicit priority markers, and splitting the text into discrete proposal units. The server assigns fields such as proposal description, priority level, related issue description, and optional rationale based on textual cues. The server outputs a collection of structured proposal records that conform to a predetermined schema for storage and display.

### Step 18

The server stores the structured proposal records and associates them with original feedback data.
The server takes as input the structured proposal records and the corresponding feedback group identifiers. The server processes this input by constructing insertion and update commands in the query language, populating a proposal table with the new records, and updating status fields in the feedback tables to indicate completion of AI-based analysis. The server outputs updated relational data structures in which each proposal record is linked via foreign keys to its originating feedback records and analysis summaries.

### Step 19

The server generates display control information for a dashboard.
The server takes as input the stored proposal records, associated index values such as computed priorities and frequencies, and category information derived from topics or product identifiers. The server processes this input by defining layout structures for a list screen and a chart screen, assigning data elements to list rows, chart axes, and visual encodings such as bar heights or segment sizes. The server embeds these structures into markup and control language instructions that allow dynamic interaction on the terminal. The server outputs display control information ready to be sent to the terminal for rendering.

### Step 20

The terminal renders the dashboard and enables user interaction with proposal information.
The terminal takes as input the display control information transmitted by the server. The terminal processes this input by parsing the markup, drawing a dashboard comprising tabular lists and charts, and running control scripts that implement filtering, sorting, and drill-down interactions. The terminal outputs a visual representation on the display device that presents the structured proposal information and allows the user to examine and manipulate the displayed data.

### Step 21

The user reviews proposals and optionally adjusts configuration for subsequent processing.
The user takes as input the dashboard view showing proposals, index values, and categories. The user processes this information by inspecting which issues are most frequent or most severe and by determining which recommendations are actionable. The user may output new configuration commands through the interface, such as modifying thresholds for grouping, changing desired output formats for future prompt sentences, or marking certain proposals as accepted or rejected, which the server records and uses as input for subsequent iterations of data processing and generative AI model invocation.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented feedback management systems typically collect user feedback as unstructured text and store such feedback in a data repository. In many implementations, analysis of the feedback relies on static rules, fixed keyword lists, or simple sentiment scores that are applied in a one-pass manner. As a result, these systems often fail to capture nuanced user intent and contextual constraints, and they cannot flexibly adapt their analysis or proposals based on ongoing user interaction. Furthermore, conventional systems generally separate the processes of natural language analysis, prompt generation, and proposal generation, such that these components are not tightly integrated into an iterative feedback loop. This separation leads to inefficiencies in computation, redundant data processing, and limited ability to refine outputs based on user responses. Another problem with known systems is that they provide only limited machine support for constructing inputs to a generative AI model. In many cases, a human operator must manually formulate a prompt, review previous outputs, and re-enter constraints or context for each new invocation of the generative AI model. This manual intervention introduces latency, inconsistency in prompt quality, and increased processing load on the operator, thereby reducing the overall effectiveness and scalability of the system. From the standpoint of computer technology, this means that the processor and its software stack are not fully leveraged to automatically transform raw feedback into structured data, into context-rich prompt sentences, and then into machine-generated proposals that can be further refined in an automated manner.

Additionally, existing systems that present AI-generated proposals often deliver only static lists of recommendations, without structured metadata such as priority information, classification information, or explicit linkage to underlying emotion values extracted from user feedback. Without such structured representation, user interfaces cannot efficiently filter, sort, or visualize the proposals, which forces the processor to perform repeated ad hoc computations and prevents the system from providing a coherent dashboard-type visualization. This reduces the usability of the system and limits the ability of computing resources to provide meaningful, real-time decision support.

Moreover, conventional feedback analysis architectures rarely implement an integrated, iterative loop in which additional user evaluation of AI-generated proposals is automatically re-ingested, reanalyzed using natural language processing, and reflected in updated context information and regenerated prompt sentences. Instead, any iteration is typically performed manually, with limited or no automatic adjustment of the underlying analysis pipeline. This lack of end-to-end automation prevents the system from continuously improving its output quality as more user interactions occur and leads to inefficient utilization of computational resources, as the processor cannot systematically reuse prior analyses or dynamically adjust prompts for the generative AI model.

Accordingly, there is a need for an improved computer-implemented system and method that: (i) automatically acquires structured data and context information from raw user feedback using natural language processing; (ii) automatically generates prompt sentences tailored to a generative AI model based on such analysis and context; (iii) converts the model's outputs into structured improvement data enriched with classification and priority information; and (iv) implements an iterative loop in which additional user responses to proposed improvement measures are automatically reanalyzed and used to regenerate prompt sentences. Such a system would improve the functioning of the computer itself by reducing manual intervention, optimizing the use of processing resources, and enabling more efficient, adaptive, and context-aware generation and presentation of improvement measures.

The specific processing by the specific processing unit 290 of the data processing device 12 in Application Example 1 is realized by the following means.

The present invention provides a server comprising a processor configured to provide, by generating and transmitting screen information to a user terminal, an interactive interface including a character input unit, a selection input unit, and an evaluation input unit on the user terminal so as to acquire evaluation information and request information from a user; to store the acquired evaluation information and request information in a storage unit, perform preprocessing including character string normalization on the acquired evaluation information and request information, and analyze the preprocessed evaluation information and request information by using a natural language processing algorithm to segment the preprocessed evaluation information and request information into units of morphemes or phrases and convert the segmented information into structured data including an emotion value, an evaluation index, and classification information; to aggregate a plurality of pieces of the structured data, and generate, on the basis of an aggregation result, context information indicating a target domain, an occurrence tendency, and constraint conditions, thereby generating aggregated information related to the evaluation information and the request information; to automatically generate, on the basis of an analysis result including the structured data and the context information and the emotion value, a prompt sentence that explicitly indicates a generation target of improvement measures, types of required measures, and implementation conditions, in accordance with a template, thereby generating a prompt sentence to be input to a generative AI model; to transmit input information including the prompt sentence and the analysis result to the generative AI model, and acquire, from the generative AI model, a generation result as text data including a plurality of improvement measures and including a content description for each of the plurality of improvement measures, thereby causing the generative AI model to generate the improvement measures; to divide the generation result into a plurality of improvement measure items, assign classification information and priority information to each of the plurality of improvement measure items, generate structured improvement data including the plurality of improvement measure items, and transmit the structured improvement data to the user terminal, thereby presenting the improvement measures; and to acquire, from the user terminal, approval information, disapproval information, or additional evaluation information from the user with respect to the structured improvement data, reanalyze the additional evaluation information by the natural language processing algorithm to update the context information, regenerate the prompt sentence on the basis of the updated context information and the approval information or the disapproval information, and re-input the regenerated prompt sentence to the generative AI model, thereby repeatedly executing a proposal process of the improvement measures. This enables the computer system to automatically transform raw user feedback into structured, context-enriched data, to generate and refine prompt sentences for a generative AI model without manual intervention, to obtain and structurally organize AI-generated improvement measures with associated metadata, and to iteratively update analysis and proposals based on further user interactions, thereby improving the efficiency, adaptability, and technical performance of the feedback analysis and proposal generation processes executed by the server.

The term “processor” refers to a hardware computing element, such as a central processing unit or a processing core, that executes instructions stored in a memory to perform logical operations, data processing, and control of system components.

The term “server” refers to an electronic computing apparatus including at least one processor, a memory, and a communication interface, configured to provide computational functions and data services to one or more user terminals over a communication network.

The term “user terminal” refers to an electronic device operated by a user, such as a portable information device, a stationary information device, or any display-capable computing device, which communicates with the server and presents an interface for input and output of information.

The term “interactive interface” refers to a graphical or textual user interface presented on a user terminal that allows a user to input information and receive system output through interactive operations, including character input, selection input, and evaluation input.

The term “character input unit” refers to a functional component of the interactive interface that enables a user to input text data, such as natural language feedback, by means of a keyboard, touchscreen, or similar input mechanism.

The term “selection input unit” refers to a functional component of the interactive interface that enables a user to select one or more options from predefined choices, for example by using checkboxes, radio buttons, dropdown menus, or other selectable elements.

The term “evaluation input unit” refers to a functional component of the interactive interface that enables a user to input an evaluation value, such as a rating, score, or level, through input controls including sliders, star ratings, numeric fields, or similar mechanisms.

The term “evaluation information” refers to information expressing a user's assessment, rating, or opinion about a subject, such as a product, service, or operation, and may include numerical ratings, qualitative comments, or categorical evaluations.

The term “request information” refers to information indicating a user's wishes, demands, or improvement requests regarding a subject, and may include explicit desired changes, feature requests, or conditions to be satisfied.

The term “storage unit” refers to a memory resource, such as a volatile memory or nonvolatile memory, configured to store data including evaluation information, request information, structured data, context information, and improvement data.

The term “preprocessing” refers to a set of operations applied to raw input data before analysis, including at least one of character string normalization, removal of extraneous characters, format unification, and segmentation preparation.

The term “character string normalization” refers to a process that converts raw text data into a standardized representation by operations such as unifying character encodings, converting variant character forms, normalizing whitespace, and removing control characters.

The term “natural language processing algorithm” refers to a software-implemented procedure that analyzes text expressed in a human language to perform tasks such as tokenization, morphological analysis, syntactic analysis, semantic analysis, sentiment analysis, and classification.

The term “morpheme” refers to a minimal linguistic unit, such as a word or word stem, obtained by morphological analysis of text during natural language processing.

The term “structured data” refers to data organized in a defined schema, such as a record or an object, including fields that represent extracted attributes from unstructured text, for example an emotion value, an evaluation index, and classification information.

The term “emotion value” refers to a quantitative or categorical representation of an emotional tendency or sentiment inferred from evaluation information or request information, such as a score indicating positive, neutral, or negative emotion.

The term “evaluation index” refers to a numerical or categorical metric derived from evaluation information or request information, representing the strength, importance, severity, or quality of user feedback.

The term “classification information” refers to one or more labels or categories assigned to evaluation information, request information, or improvement measures, indicating attributes such as topic, domain, type of issue, or functional area.

The term “aggregation” refers to a process of combining a plurality of pieces of structured data to compute summary statistics, distributions, or grouped results for a target domain, a period, or a category.

The term “aggregation result” refers to a data set or summary that is obtained by aggregating a plurality of pieces of structured data and that includes, for example, counts, ratios, averages, trends, or other statistical indicators.

The term “context information” refers to information derived from aggregation results and other metadata that describes a surrounding situation of evaluation information and request information, including at least a target domain, an occurrence tendency, and constraint conditions.

The term “target domain” refers to an application area or subject category to which evaluation information, request information, or improvement measures relate, such as a product area, a service area, or an operational area.

The term “occurrence tendency” refers to a pattern or trend in the appearance of particular issues, sentiments, or categories over time or across groups, as derived from aggregated structured data.

The term “constraint conditions” refers to conditions or limitations that affect feasible improvement measures, such as budget limitations, time constraints, resource availability, or policy restrictions.

The term “generative AI model” refers to a machine learning model, such as a large language model, that generates text data or other output data by predicting or sampling from learned probability distributions conditioned on an input, such as a prompt sentence.

The term “prompt sentence” refers to a text sequence or structured text input that instructs a generative AI model about a task, context, constraints, and desired output format, and that is provided by the processor to the generative AI model.

The term “analysis result” refers to the output of the natural language processing algorithm applied to evaluation information and request information, including at least structured data and optionally context information and emotion values.

The term “generation result” refers to the output text or data that is produced by the generative AI model in response to a provided prompt sentence and analysis result, and that includes at least a plurality of improvement measures.

The term “improvement measures” refers to proposed actions, strategies, or changes intended to address issues identified in the evaluation information and request information, which may include operational changes, communication improvements, or policy adjustments.

The term “improvement measure item” refers to an individual, discrete element of an improvement measure, including at least a description of an action and optionally associated classification information and priority information.

The term “structured improvement data” refers to a data representation in which one or more improvement measure items are organized with defined fields, including classification information, priority information, and any additional metadata.

The term “priority information” refers to an attribute assigned to an improvement measure item that indicates a recommended order of execution, importance level, or urgency.

The term “approval information” refers to information indicating that a user has accepted, agreed to, or selected a particular improvement measure item or set of items.

The term “disapproval information” refers to information indicating that a user has rejected, disagreed with, or deselected a particular improvement measure item or set of items.

The term “additional evaluation information” refers to further feedback, comments, or constraints provided by a user with respect to previously proposed improvement measures, after initial proposals have been presented.

The term “proposal process” refers to a sequence of operations in which the processor generates, refines, and presents improvement measures, including analysis of feedback, prompt generation, generative AI invocation, and post-processing of results.

The term “product domain” refers to a category or group of goods or tangible offerings to which evaluation information and request information relate.

The term “service domain” refers to a category or group of services or intangible offerings to which evaluation information and request information relate.

The term “customer segment” refers to a subset of users or customers grouped according to one or more attributes, such as demographics, usage behavior, or purchase history.

The term “measure candidate” refers to a proposed measure produced by the generative AI model that is a potential element of a sales policy, service policy, or operation policy, prior to final selection or implementation.

The term “sales policy” refers to a set of principles, strategies, or procedures governing sales activities, which may be constructed from one or more measure candidates.

The term “service policy” refers to a set of principles, strategies, or procedures governing service provision activities, which may be constructed from one or more measure candidates.

The term “operation policy” refers to a set of principles, strategies, or procedures governing internal or external operational activities, which may be constructed from one or more measure candidates.

The term “screen information” refers to data defining elements of a user interface to be displayed on a user terminal, including layout, text, graphical components, and interaction controls.

The term “visualization information” refers to information formatted for graphical or structured display, including representations such as charts, graphs, indicator values, and lists that depict analysis results or improvement measures.

The term “index value” refers to a numerical indicator used to quantify a property of an improvement measure or analysis result, such as a score, rating, or computed metric.

The term “graphical display” refers to a visual representation, such as a chart, graph, or diagram, that displays index values, trends, or relationships derived from structured data or structured improvement data.

The term “list display” refers to a visual representation where items such as improvement measures or analysis results are presented in a sequential or tabular list format, optionally with associated metadata.

The term “dashboard format” refers to a composite display format in which multiple visualization elements, such as index values, graphical displays, and list displays, are simultaneously presented on one or more screens to provide an overview of analysis results and improvement measures.

In one embodiment, a server executes a feedback analysis and improvement proposal system using a combination of general-purpose computing hardware and specialized software components. The server includes at least one central processing unit (CPU), a main memory, a non-volatile storage device, and a network interface. The server executes an operating system and one or more application programs implemented, for example, in an object-oriented programming language. The server communicates with one or more terminals through a communication network such as a wired or wireless packet network.

A terminal operates as a user terminal and includes a processor, a display, an input device such as a touch panel, and a network interface. The terminal executes an application program or a web browser to render an interactive interface controlled by the server. The interactive interface includes a character input unit, a selection input unit, and an evaluation input unit that are implemented as graphical user interface elements such as text boxes, checkboxes, radio buttons, sliders, and rating bars.

The server provides the interactive interface by generating screen information that describes layout, input elements, and display content, and by transmitting the screen information to the terminal. The terminal displays the interface on the display and accepts user operations. The user enters evaluation information and request information in natural language through the character input unit, selects predefined categories or issues through the selection input unit, and provides rating values or scores through the evaluation input unit.

The server receives the evaluation information and request information from the terminal via a network protocol such as HTTP over Transport Layer Security. The server stores the received information in a storage unit as records that include user identifiers, timestamps, raw text fields, numerical scores, and selected category codes. The server performs preprocessing of the stored information by executing character string normalization routines that unify encoding, convert variant characters, standardize whitespace, and remove control characters. The server thereby converts heterogeneous raw text into a canonical representation that can be efficiently processed.

The server analyzes the normalized text using a natural language processing algorithm implemented as a sequence of computational modules. In one embodiment, the server uses a tokenization module to segment the text into lexical units, a part-of-speech tagging module to assign grammatical categories, and a dependency parsing module to determine syntactic relations. The server further uses a sentiment analysis model to compute an emotion value for each text segment. The emotion value is represented as a real-valued score vector indicating degrees of positive, negative, and neutral sentiment, or as a scalar mapped from such a vector.

In a specific embodiment, the sentiment analysis model and a classification model share a neural network architecture implemented as a multi-layer transformer model. The server configures the generative AI model as a decoder-only transformer including a plurality of self-attention layers, feed-forward layers, and layer normalization units. The server pre-trains this model on a large corpus of text and fine-tunes it on domain-specific feedback data. During fine-tuning, the server uses a loss function that combines cross-entropy loss for token prediction with an auxiliary loss term for sentiment classification or category classification. The server updates the model parameters by a stochastic gradient descent method or a variant such as Adam, using mini-batches of training examples. The server may perform data augmentation by paraphrasing feedback sentences or by injecting noise into input text to improve robustness.

The server derives structured data from the output of the natural language processing algorithm. The structured data includes fields such as an emotion value, one or more evaluation indices representing severity or importance, and classification information including topic labels and domain codes. The server stores the structured data in a relational or document-oriented data structure that uses keys, indexes, and schema definitions optimized for later aggregation. This specific data structure allows the server to compute aggregations using indexing and vectorized operations rather than repeated full-text scans, thereby reducing computational load and improving response time.

The server aggregates a plurality of pieces of structured data collected over time. The server groups the structured data by product domain, service domain, customer segment, or other classification information, and computes aggregation results such as frequency distributions, moving averages of emotion values, and time series of evaluation indices. The server constructs context information based on these aggregation results. The context information includes a target domain, occurrence tendencies such as increased frequency of certain complaint types, and constraint conditions derived from explicit user comments or external configuration. By storing context information as a compact representation, the server can reuse it across multiple invocations of the generative AI model, which reduces redundant computation and communication overhead.

The server generates a prompt sentence for a generative AI model by combining the structured data, the context information, and the emotion values. The server maintains one or more prompt templates in memory. Each template specifies a sentence structure that includes placeholders for feedback text, categories, main issues, context summary, and constraints.

The server fills the placeholders with corresponding values and produces a complete prompt sentence in natural language. Because the server uses templates and structured data, the server automatically generates consistent, context-rich prompt sentences without human intervention, and can adapt the level of detail depending on resource constraints.

In one example, the user provides feedback through the terminal in the form:
“The delivery was slow and the package was damaged.”

The server stores this text, normalizes it, and converts it into structured data that designates “delivery” as the target domain, extracts main issues “delivery was slow” and “package was damaged,” and assigns a negative emotion value. The server aggregates similar feedback in the same period and computes that 32% of delivery-related feedback includes slow delivery and 12% includes package damage. The server then generates the following example prompt sentence:
“Analyze the following customer feedback and propose specific improvement measures.

Customer feedback: ‘The delivery was slow and the package was damaged.’
Category: delivery
Main issues: delivery was slow; package was damaged
Context: Over the last 30 days, 32% of delivery feedback reported slow delivery, and 12% reported package damage.
Please output several practical and actionable improvement measures.”

In another example, after the user disapproves certain proposals due to budget constraints, the server generates a refined prompt sentence:
“Previously proposed measures that involve changing the logistics partner were rejected because the budget is limited and the company must keep its current partner.
Under these constraints, please propose alternative low-cost measures to shorten delivery time and reduce package damage, such as process optimizations or better internal quality checks.
Provide at least five concrete and feasible actions.”

The server transmits such a prompt sentence to the generative AI model as part of input information. In one embodiment, the generative AI model operates as a neural sequence-to-sequence generator that receives the prompt sentence tokenized into subword units and produces output tokens according to learned probability distributions. The server controls the decoding algorithm by parameters such as maximum token length, temperature, and top-k or nucleus sampling thresholds. These parameters are stored in configuration data and can be optimized for trade-offs between diversity and determinism of generated measures.

The server receives a generation result from the generative AI model as a text block containing multiple improvement measures separated by line breaks or numbered lists. The server parses the generation result by using deterministic rules and, optionally, an auxiliary classification model. The server splits the generation result into individual improvement measure items, each represented by a title, a detailed description, and extracted keywords.

The server assigns classification information and priority information to each improvement measure item by applying a classification algorithm that considers semantic similarity between item descriptions and known category vectors, as well as emotion values of related feedback. The server represents the improvement measure items as structured improvement data in a defined schema.

The server transmits the structured improvement data to the terminal. The terminal renders a set of user interface components based on the structured improvement data, such as a list of improvement measure items displayed with their classification labels, priority levels, and related emotion indicators. The user reviews the list and provides approval information, disapproval information, or additional evaluation information using buttons and comment areas. The terminal sends these inputs back to the server.

The server receives the approval information, disapproval information, and additional evaluation information and stores them in association with the corresponding improvement measure items and the original feedback. The server applies the natural language processing algorithm again to the additional evaluation information to extract new constraints, preferences, or clarifications. The server updates the context information to reflect the new constraints, such as prohibition of certain types of measures or a requirement for low-cost solutions. The server constructs a new prompt sentence using the updated context information and the prior decision history, and transmits this prompt sentence to the generative AI model. This iterative loop allows the server to refine proposed improvement measures in response to user interaction while minimizing the need for manual prompt authoring.

The described architecture improves computer technology in several ways. First, the server uses a specific structured data representation and aggregation mechanism that reduces the need to repeatedly process full raw text, resulting in lower processing time and memory usage. Second, the server automatically generates context-rich prompt sentences based on structured data, which improves the relevance and consistency of generative AI outputs compared to manually crafted prompts. This reduces the number of iterations needed to reach satisfactory proposals, thereby reducing processing load and network traffic between the server and the model execution environment.

Third, the server implements a non-conventional control flow in which additional user feedback on generated proposals is systematically re-ingested, converted into structured constraints, and used to update context information and regenerate prompt sentences. This loop is not a mere automation of human review work; the loop exploits the structured data, emotion values, and classification information to modify the internal state of the system and to adapt subsequent generative computations. As a result, the server realizes improved accuracy and reduced error rates in aligning proposed measures with implicit user requirements.

Fourth, by decomposing the generative AI model interaction into explicit modules of prompt generation, model invocation, and post-processing, and by defining specific data structures for inputs and outputs, the server can optimize caching and reuse of intermediate results. For example, the server can reuse context information and partial analyses across multiple sessions concerning the same product domain, thereby decreasing redundant computations and improving throughput.

In another embodiment, the server adjusts model parameters or decoding strategies depending on the aggregated emotion values and occurrence tendencies. For highly negative feedback with frequent recurrence, the server can bias the generative AI model toward more conservative, risk-mitigating measures by selecting specific decoding parameter values. For infrequent but severe issues, the server can permit broader exploration of measures by relaxing constraints. This dynamic parameterization is performed by the processor according to deterministic rules based on structured data, rather than by manual tuning, and leads to an improvement in computational efficiency and quality of generated outputs.

In yet another embodiment, the server deploys multiple generative AI models with different network architectures or training data sets, and selects an appropriate model based on target domain or constraint conditions contained in the context information. The server may choose a compact model for low-latency responses in real-time scenarios or a larger model for more complex analysis. This model selection and routing mechanism is implemented by a control module in the server and results in reduced latency and optimized resource usage.

The system can be applied to various use cases beyond a particular business domain. For example, the server can process feedback regarding reliability of technical equipment, safety of environments, or usability of software applications. In each case, the server uses the same technical framework: acquisition of feedback via an interactive interface on a terminal, structured analysis using natural language processing, generation of prompt sentences tailored to a generative AI model, and iterative refinement of improvement measures using structured improvement data and updated context information. These techniques provide a general improvement to computer-based feedback processing and proposal generation, making it possible to achieve higher precision, faster processing, and more efficient data management than systems that rely on static rules or manual prompt construction.

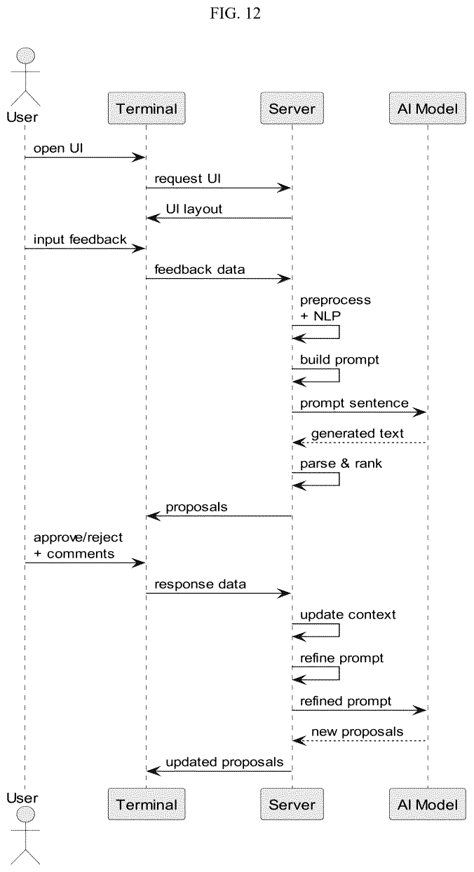

The following describes the processing flow using FIG. 12.

### Step 1

The server generates screen information defining an interactive interface and transmits the screen information to the terminal.
The input is configuration data specifying a character input unit, a selection input unit, and an evaluation input unit.
The server converts this configuration data into a structured screen description including layout coordinates, widget types, labels, and validation rules, and outputs the screen description to the terminal via a network.

### Step 2

The terminal renders the interactive interface based on the received screen information and displays it to the user.
The input is the screen description from the server.
The terminal parses the description, instantiates corresponding user interface components (text box, checkboxes, rating bar, buttons), and outputs a graphical interface on the display.

### Step 3

The user inputs evaluation information and request information using the interactive interface on the terminal.
The input is the displayed interface with the character input unit, selection input unit, and evaluation input unit.
The user types natural language text into the character input unit, selects issue categories via the selection input unit, assigns a rating via the evaluation input unit, and outputs a completed feedback form by activating a submission control on the terminal.

### Step 4

The terminal collects the user's input and transmits the collected data to the server.
The input is the text entered by the user, the selected options, the rating value, and terminal-side metadata such as a local timestamp and session identifier.
The terminal packages these values into a structured message including fields for feedback text, selected categories, numerical rating, user identifier, and timestamps, and outputs the structured message to the server over a secure communication channel.

### Step 5

The server receives the structured message and stores raw feedback data in a storage unit.
The input is the structured message transmitted from the terminal.
The server validates required fields, assigns an internal feedback identifier, and writes a raw feedback record including text, selection values, ratings, and metadata into a database, and outputs a stored record status and identifier.

### Step 6

The server performs preprocessing on the stored feedback text by executing character string normalization.
The input is the raw feedback record including a text field.
The server normalizes character encoding to a uniform format, converts variant characters (such as full-width to half-width), removes control characters, standardizes whitespace, and outputs a canonical text string associated with the feedback identifier.

### Step 7

The server applies a natural language processing algorithm to analyze the normalized text and generate structured data.
The input is the canonical text string for each feedback record.
The server executes tokenization to split the text into tokens, performs part-of-speech tagging and dependency parsing, applies a sentiment analysis model to compute an emotion value, and applies a classification model to assign categories and subcategories.
The server integrates these results into structured data fields including emotion value, evaluation index, and classification information, and outputs a structured data record linked to the original feedback.

### Step 8

The server aggregates multiple structured data records and computes aggregation results.
The input is a set of structured data records over a specified time interval or domain.
The server groups the records by product domain, service domain, or customer segment, calculates statistics such as counts, ratios, moving averages of emotion values, and occurrence frequencies of specific issues, and outputs aggregation results including trend indicators and distribution summaries.

### Step 9

The server generates context information based on the aggregation results.
The input is the aggregation results from Step 8.
The server extracts target domains with high complaint ratios, identifies occurrence tendencies such as increasing frequency of a particular issue, and collects constraint conditions detected in user comments or system configuration, and outputs context information describing the domain, tendencies, and constraints in a compact data structure and optional textual summary.

### Step 10

The server constructs a prompt sentence for a generative AI model using the structured data and the context information.
The input is the structured data for a specific feedback record, the corresponding context information, and the associated emotion value.
The server selects a prompt template, inserts the feedback text, category, main issues, context summary, and any constraints into the template, and outputs a completed prompt sentence that explicitly specifies a generation target, required measure types, and implementation conditions.

### Step 11

The server sends the prompt sentence and analysis result to the generative AI model and obtains a generation result.
The input is the prompt sentence and, optionally, structured data fields passed as additional context.
The server encodes the prompt sentence into tokens, transmits the encoded tokens and configuration parameters (such as maximum output length and decoding strategy) to the generative AI model, and receives a text output that includes multiple improvement measures with descriptive content.
The server outputs the received text as a generation result associated with the feedback identifier.

### Step 12

The server parses the generation result into individual improvement measure items and generates structured improvement data.
The input is the text output from the generative AI model.
The server identifies separators such as numbering or line breaks, extracts each improvement description, assigns a title, and applies a classification algorithm to determine category labels and a rule-based or model-based estimator to assign priority information.
The server organizes each item into a structured format including title, description, classification information, and priority information, and outputs structured improvement data linked to the feedback.

### Step 13

The server transmits the structured improvement data to the terminal for presentation to the user.
The input is the structured improvement data generated in Step 12.

The server converts the structured data into display-ready elements such as item labels, priority indicators, and category tags, and outputs presentation data to the terminal via the communication network.

### Step 14

The terminal renders the improvement measure items and allows the user to provide responses.
The input is the presentation data received from the server.
The terminal displays a list or dashboard of improvement measure items, showing titles, descriptions, categories, and priority levels, and presents interactive controls for approval, disapproval, and comment entry.
The terminal outputs user actions and any additional evaluation text as response data.

### Step 15

The user reviews the presented improvement measures and supplies approval information, disapproval information, or additional evaluation information through the terminal.
The input is the displayed set of improvement measures with associated controls.
The user selects items to approve or disapprove and enters comments such as constraints, preferences, or clarifications in natural language, and outputs a completed response form via a submission operation on the terminal.

### Step 16

The terminal collects the user's responses and sends them to the server.
The input is the user's selection states, comments, and local metadata.
The terminal assembles this information into a structured response message that includes fields for proposal identifiers, decision types (approval or disapproval), and additional evaluation text, and outputs the structured response message to the server.

### Step 17

The server receives the structured response message, stores the response, and reanalyzes the additional evaluation information.
The input is the structured response message from the terminal.
The server writes the approval information, disapproval information, and additional evaluation information into the storage unit in association with the corresponding improvement measure items and original feedback, then applies the natural language processing algorithm to the additional evaluation text to extract new constraints, preferences, and sentiment.
The server outputs updated structured data and revised constraint indicators.

### Step 18

The server updates the context information based on the reanalysis of additional evaluation information.
The input is the updated structured data and constraint indicators derived from the user's responses.
The server adjusts the occurrence tendencies and constraint conditions for the relevant target domain, marks rejected measure types, and refines the context summary to reflect the user's explicit limitations or requirements, and outputs updated context information.

### Step 19

The server regenerates a refined prompt sentence and re-invokes the generative AI model.
The input is the updated context information, prior decision history (approval and disapproval), and original structured data.
The server selects a refinement template that includes references to previously rejected measures and newly imposed constraints, inserts updated values into the template, and outputs a refined prompt sentence that instructs the generative AI model to propose alternative measures satisfying the new conditions.
The server then sends the refined prompt sentence to the generative AI model in the same manner as in Step 11 and outputs a new generation result for further parsing and presentation.

### Step 20

The server and terminal repeat the parsing, structuring, presentation, and response collection steps until the user indicates completion.
The input is successive generation results, structured improvement data, and user responses.
The server iteratively performs data transformations from text to structured records, from structured records to prompt sentences, and back from model outputs to refined proposals, while the terminal continuously renders updated proposals for user interaction.
The system outputs a converged set of improvement measures that reflect both aggregated feedback patterns and user-specific constraints, with reduced processing overhead and improved alignment with user intent.
It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional feedback analysis systems typically rely on separate and weakly integrated components for data collection, natural language processing, sentiment analysis, and decision support. In many implementations, user opinion information and request information are merely stored as unstructured text and are analyzed in a batch, offline manner using generic text mining tools. As a result, several technical problems arise in the context of computer-implemented feedback analysis.

First, a processor in such systems often performs redundant or ad hoc preprocessing of text data, without a unified pipeline that normalizes character strings, removes unnecessary symbols, and removes function words in a consistent manner. This leads to inconsistent analysis text data, which degrades the accuracy and stability of subsequent sentiment classification processing. From a computer technology perspective, inefficient preprocessing pipelines cause unnecessary memory accesses and repeated computation, thereby increasing processing latency and resource consumption across large-scale feedback datasets.

Second, existing systems frequently treat a deep learning sentiment classifier and a generative artificial intelligence model as separate tools that are manually invoked by an operator. The processor typically does not automatically aggregate sentiment labels and confidence information into structured statistical information, such as sentiment tendency information and issue extraction information, in a way that is directly consumable by a generative artificial intelligence model. As a consequence, the generative artificial intelligence model is often driven by manually crafted, non-systematic prompt sentences that do not reflect the underlying statistical structure of the feedback data. This results in suboptimal use of computational resources on the server side, inconsistent output quality from the generative artificial intelligence model, and increased operator workload.

Third, conventional systems generally do not provide a mechanism in which a processor automatically generates prompt data, including classification condition information and major issue information, to programmatically steer a generative artificial intelligence model to group multiple pieces of opinion information and request information into logical issue groups and to generate improvement measure information and marketing measure information per group. Without such prompt orchestration at the system level, the generative artificial intelligence model operates on loosely defined instructions, which limits its ability to produce structured, machine-usable results. This restricts the extent to which the system can close the loop between low-level text analysis and high-level decision support within a single integrated computing architecture.

Fourth, many feedback analysis tools output static reports or simple dashboards that do not support the management of execution state information associated with individual improvement measures or marketing measures generated by an artificial intelligence model. The processor in such systems often only renders visualization data without any persistent linkage between the generative suggestions and their execution states. Consequently, the system cannot maintain a coherent, machine-readable record of which suggestions have been planned, are in progress, or have been completed. This limits the ability of the system to serve as an integrated technical platform for continuous, data-driven product and service improvement.

Thus, there is a need for an improved computer-implemented system in which a processor: (i) performs structured preprocessing and sentiment classification of user opinion information and request information; (ii) aggregates sentiment labels and confidence information into statistical information and issue extraction information; (iii) automatically generates prompt data to drive a generative artificial intelligence model in a controlled and reproducible manner; and (iv) reconstructs report information and visualization screens that not only present analysis results but also manage execution state information for improvement measures and marketing measures. Such a system should enhance processing efficiency, improve the technical quality and consistency of model outputs, and reduce operator intervention by integrating these components into a single, coordinated server-side architecture.

The specific processing by the specific processing unit 290 of the data processing device 12 in Example 2 is realized by the following means.

The present invention provides a server comprising a processor and a storage unit, the processor being configured to receive, via a communication terminal, opinion information and request information from a user and store the opinion information and the request information as structured information in the storage unit; execute, by using a natural language processing program, preprocessing including character string normalization processing, unnecessary symbol removal processing, and function word removal processing on the opinion information and the request information stored in the storage unit to generate analysis text data; execute, by using a sentiment classification process based on a deep learning algorithm, processing on the analysis text data as input to calculate, for each piece of text data, a sentiment label including at least one of positive, negative, and neutral, and confidence information corresponding to the sentiment label, and to store the sentiment label and the confidence information in association with the opinion information and the request information in the storage unit; aggregate, based on the sentiment label and the confidence information stored in the storage unit, statistical information on at least one of a product unit, a time unit, and a user attribute unit to generate sentiment tendency information and issue extraction information; automatically generate prompt data defining a prompt sentence to be input to a generative artificial intelligence model, the prompt data being generated based on analysis result information including at least a part of the sentiment tendency information, the issue extraction information, and the opinion information and the request information; transmit the prompt data to the generative artificial intelligence model and acquire, from the generative artificial intelligence model, response information including improvement measure information and marketing measure information derived based on the analysis result information and the sentiment label; and reconstruct report information by associating the acquired response information with the statistical information, generate a visualization screen based on the report information, and output display control information for causing the visualization screen to be displayed in a dashboard format, the display control information including operation information that enables execution state information to be assigned to each item of the improvement measure information and the marketing measure information and enabling updated execution state information to be stored in association with the report information in the storage unit. This enables an integrated computer-implemented feedback analysis workflow in which preprocessing, sentiment classification, statistical aggregation, prompt-based control of a generative artificial intelligence model, and interactive dashboard management are coherently orchestrated by the server, thereby improving processing efficiency, enhancing consistency and structure of model outputs, and reducing manual intervention in generating, organizing, and tracking improvement measures and marketing measures.

The term “system” refers to a combination of one or more computing devices, including at least one processor and at least one storage unit, configured to execute programmed instructions to perform the functions described herein.

The term “processor” refers to one or more hardware processing units, such as a central processing unit or a graphics processing unit, capable of executing machine-readable instructions to perform arithmetic, logical, control, and input/output operations.

The term “storage unit” refers to one or more non-transitory computer-readable media, such as semiconductor memory, magnetic storage, or optical storage, configured to store data and programs used by the processor.

The term “communication terminal” refers to an electronic device, such as a client computer, a mobile device, or a network-enabled appliance, configured to transmit data to and receive data from the server over a communication network.

The term “user” refers to a human operator or an organization that uses the communication terminal to provide opinion information and request information and to view analysis results and dashboards.

The term “opinion information” refers to text data or other user-provided information expressing evaluations, impressions, or comments regarding a product, a service, or an experience.

The term “request information” refers to text data or other user-provided information expressing needs, demands, suggestions, or desired improvements regarding a product, a service, or an experience.

The term “structured information” refers to data stored in a predefined schema or data structure, such as records, fields, or tables, enabling the data to be efficiently retrieved and processed by the processor.

The term “natural language processing program” refers to a software component that implements one or more algorithms for processing and transforming human language text into a representation suitable for computational analysis.

The term “analysis text data” refers to text data derived from opinion information and request information after having undergone one or more preprocessing operations, and used as input to sentiment classification and further analysis.

The term “character string normalization processing” refers to operations that convert text into a canonical form, including but not limited to case conversion, character standardization, and removal or normalization of control characters.

The term “unnecessary symbol removal processing” refers to operations that detect and remove symbols, characters, or markup that are not relevant to the semantic content of the text, such as certain punctuation, decorative symbols, or formatting codes.

The term “function word removal processing” refers to operations that remove words with low semantic content, such as articles, conjunctions, and prepositions, in order to focus analysis on content-bearing words.

The term “sentiment classification process” refers to computational operations that assign one or more sentiment categories to a unit of text based on its linguistic content.

The term “deep learning algorithm” refers to a machine learning technique that uses a multi-layer neural network to learn complex patterns from data and to produce outputs such as sentiment labels from input text.

The term “sentiment label” refers to a categorical indicator representing an emotional polarity or attitude of a unit of text, including at least one of a positive sentiment, a negative sentiment, and a neutral sentiment.

The term “confidence information” refers to numerical data indicating a degree of certainty or probability associated with a sentiment label or other classification result produced by a computational model.

The term “statistical information” refers to aggregated numerical data derived from multiple sentiment labels and confidence information, including counts, ratios, distributions, or trends over defined units.

The term “product unit” refers to a classification axis in which statistical information is aggregated according to identifiers or categories of products or services.

The term “time unit” refers to a classification axis in which statistical information is aggregated according to temporal segments, such as days, weeks, months, or other defined time intervals.

The term “user attribute unit” refers to a classification axis in which statistical information is aggregated according to attributes associated with users, such as demographic attributes, usage patterns, or device types.

The term “sentiment tendency information” refers to information indicating one or more patterns, distributions, or trends of sentiment labels over at least one of a product unit, a time unit, and a user attribute unit.

The term “issue extraction information” refers to information indicating one or more issues, problems, or themes automatically identified from opinion information, request information, sentiment labels, and statistical information.

The term “analysis result information” refers to information including at least a portion of sentiment tendency information, issue extraction information, and the corresponding opinion information and request information, and representing an outcome of data analysis performed by the processor.

The term “generative artificial intelligence model” refers to a computational model that generates new text or other data based on input prompts and learned parameters, and that can produce response information including improvement measures and marketing measures.

The term “prompt sentence” refers to a natural language instruction or query provided as input to a generative artificial intelligence model to specify a task, a context, or a desired format of output.

The term “prompt data” refers to data defining a prompt sentence, including the prompt text and optionally associated parameters, to be supplied to a generative artificial intelligence model.

The term “classification condition information” refers to data indicating one or more criteria or rules for grouping a plurality of pieces of opinion information and request information into logical issue groups.

The term “major issue information” refers to information representing one or more dominant or high-priority issues automatically identified from statistical information and analysis result information.

The term “logical issue group” refers to a collection of one or more pieces of opinion information and request information that satisfy common classification conditions and are grouped as representing a related issue or theme.

The term “response information” refers to information generated by a generative artificial intelligence model in response to prompt data, including at least improvement measure information and marketing measure information.

The term “improvement measure information” refers to information describing one or more proposed actions, changes, or enhancements intended to improve a product, a service, or an experience.

The term “marketing measure information” refers to information describing one or more proposed actions or strategies for promoting, positioning, or communicating a product, a service, or an experience.

The term “report information” refers to data that combines statistical information, response information, and optionally execution state information into a form suitable for visualization and user interpretation.

The term “visualization screen” refers to a graphical user interface screen that displays report information using graphical elements such as charts, tables, and textual summaries.

The term “display control information” refers to information output by the processor to control a display device or a user interface component to present a visualization screen in a specified format.

The term “dashboard format” refers to a layout of a visualization screen that simultaneously presents multiple indicators, charts, or panels summarizing report information in a consolidated view.

The term “operation information” refers to data or parameters that define interactive controls or user interface elements enabling a user to input or modify execution state information for improvement measures or marketing measures.

The term “execution state information” refers to information indicating a status of implementation of an improvement measure or a marketing measure, including but not limited to planned, in progress, or completed.

The term “updated execution state information” refers to execution state information that has been modified by a user operation and stored again in association with corresponding report information.

In one embodiment, a server includes at least one processor, a main memory, a non-transitory storage device, and a network interface connected via a hardware bus. The server is connected through a communication network to at least one terminal operated by a user. The terminal includes a display device, an input device, a local memory, and a communication interface. The server executes a feedback analysis program stored in the storage device to implement the claimed system.

The server executes an operating system, such as a general-purpose server operating system, and an application stack including a web application framework (for example, a framework of the type of Django, Flask, or Express) and a backend analysis component implemented in a high-level programming language. The server stores user feedback data in a relational database system of the type of MySQL or PostgreSQL, which is installed on the same machine or on a separate database server. The server optionally utilizes a general-purpose computation accelerator, such as a GPU, for deep learning-based processing.

The terminal executes a web browser or a native application and displays a graphical user interface for collecting user feedback. The terminal presents input fields for opinion information and request information, including free-text comment areas and numeric or categorical rating controls. The terminal performs initial client-side validation, such as checking that required fields are not empty, before transmitting data to the server via a secure communication protocol.

The server stores each piece of opinion information and request information as structured information in the relational database. The server defines a schema that includes at least the following fields: a feedback identifier, a user identifier, a product or service identifier, a timestamp, original text fields for opinion information and request information, and auxiliary attributes such as device type and interface language. The server further defines fields for analysis text data, sentiment labels, confidence scores, statistical aggregation identifiers, issue group identifiers, and execution state information for improvement measures and marketing measures.

The server applies a natural language processing program to the stored opinion information and request information. In one embodiment, the server uses a natural language processing library of the type of spaCy, NLTK, or a tokenizer of the type of a transformer-based model library. The server performs character string normalization processing, including Unicode normalization and case folding, to unify text representation. The server performs unnecessary symbol removal processing to delete symbols that do not contribute to semantic analysis, such as decorative punctuation and markup artifacts. The server performs function word removal processing by referencing a stop-word list customized for the application domain.

The server generates analysis text data by tokenizing the normalized text into tokens and optionally applying lemmatization to convert inflected word forms to base forms. The server stores the analysis text data as a separate field, such as a token sequence or a normalized string, associated with the original feedback record. This structured storage enables the server to reuse the analysis text data across multiple processing stages without repeating costly preprocessing, thereby improving processing efficiency and reducing memory and CPU consumption.

The server executes a sentiment classification process based on a deep learning algorithm. In one embodiment, the server uses a neural network of the transformer architecture type, similar to a bidirectional encoder model. The network includes an embedding layer that maps token identifiers to dense vectors, multiple self-attention layers, and a classification head that outputs a probability distribution over sentiment categories. The server converts the analysis text data into token identifiers using a tokenizer consistent with the neural network architecture. The server generates input tensors, such as token ID sequences and attention masks, and transfers them to a computation device such as a GPU when available.

The server computes, for each input sequence, a sentiment label selected from at least positive, negative, and neutral categories. The server calculates confidence information by applying a softmax function to the output logits of the classification head. The server stores the sentiment label and the associated confidence information in the relational database in association with each feedback record. The use of a deep learning algorithm with multi-layer self-attention enables the server to capture long-range dependencies and nuanced sentiment expressions, which improves classification accuracy compared to conventional bag-of-words or rule-based methods.

The server trains the deep learning model in advance on a training dataset containing labeled feedback texts. During training, the server minimizes a loss function, such as cross-entropy loss, computed between predicted sentiment distributions and ground truth labels. The server updates model parameters by using an optimization algorithm, such as stochastic gradient descent with adaptive learning rates. The server may employ data augmentation techniques, such as synonym replacement or back-translation, to increase training data diversity and reduce overfitting. By disclosing such training methods, the internal behavior of the model is concretely defined rather than treated as an opaque black box.

The server aggregates sentiment labels and confidence information into statistical information. The server executes grouping queries over the feedback table to compute distributions of sentiment labels per product unit, time unit, and user attribute unit. The server calculates metrics such as the proportion of negative feedback for a particular product in a specific time period, average confidence scores per category, and changes in positive sentiment over time. The server derives sentiment tendency information by identifying statistically significant shifts or anomalies, such as a sudden increase in negative feedback after a software update. The server generates issue extraction information by associating frequent terms or phrases in analysis text data with clusters of negative or mixed sentiment, for example by using term frequency-inverse document frequency measures or clustering algorithms.

The server automatically generates prompt data that defines a prompt sentence to be input to a generative AI model. The server composes prompt sentences programmatically, based on analysis result information including sentiment tendency information, issue extraction information, and representative opinion information and request information. In one example, the server generates a prompt sentence for analyzing a single feedback item as follows:
“Classify the sentiment (positive, negative, neutral) of the following feedback and explain the reasons. Then propose two concrete improvement actions. Feedback: ‘This app is convenient but the performance is slow.’

In another example, the server generates a prompt sentence for grouping multiple feedback items:
“Given the following customer feedback comments about our mobile app, group them into categories (e.g., startup speed, screen loading, crashes, usability) and summarize the main issues in each category. Then propose specific technical or design improvements. Feedback list: [list of comments].”

In yet another example, the server generates a prompt sentence for periodic summary:
“Based on the feedback received in the last 30 days about our service, identify the top three causes of user dissatisfaction and the top three strengths. For each cause of dissatisfaction, propose at least two actionable improvement measures that a product team can implement.”

The server embeds, into the prompt data, classification condition information representing grouping criteria (such as product category or issue type) and major issue information derived from the statistical information (such as the most frequent negative themes). This explicit, machine-generated prompt structure differs from ad hoc human-authored prompts and is tailored to efficiently drive the generative AI model toward structured and domain-relevant outputs. As a result, the server reduces variability in model responses and optimizes computation by avoiding irrelevant or redundant queries.

The server transmits the prompt data to a generative AI model deployed either as a cloud-based inference service or as an on-premise model running on local GPU hardware. The generative AI model may be implemented as a large-scale transformer-based language model trained with unsupervised or semi-supervised learning on large corpora of text. The server specifies model parameters such as maximum output length and temperature, which control the determinism and diversity of output. The server receives response information from the generative AI model, including improvement measure information and marketing measure information structured according to the prompt sentence.

The server parses the response information. In one embodiment, the server constrains the generative AI model via the prompt to output results in a semi-structured textual format, such as enumerated lists for each issue group. The server extracts improvement measures and marketing measures, associates them with logical issue groups derived from classification condition information, and stores them in corresponding database tables. This structured storage allows the server to later update execution state information for each measure and to re-query the generative AI model with focused prompts.

The server reconstructs report information by combining statistical information with the response information. The server generates a data structure containing, for each logical issue group, aggregated sentiment metrics, representative feedback texts, proposed improvement measures, and marketing strategies. The server prepares visualization screen data by mapping this report information into chart descriptors, table definitions, and text panels. A web application on the server renders a dashboard format interface, for example, using a JavaScript charting library of the type of Chart.js or Plotly. The server outputs display control information that instructs the terminal to draw specific charts, such as bar graphs of sentiment distribution and timelines of sentiment changes, together with lists of improvement measures and their execution states.

The terminal displays the dashboard on the display device and presents interactive controls that allow the user to assign execution state information, such as “planned,” “in progress,” and “completed,” to each improvement measure and marketing measure. The terminal transmits the user's operations to the server. The server updates the corresponding execution state fields in the database while maintaining associations with the underlying statistical and analytical data. This creates a persistent, machine-processable link between analysis results and follow-up actions, which is not achieved by conventional static reporting tools.

The server improves computer technology in several concrete ways. First, the server reduces redundant preprocessing by separating and caching analysis text data, which decreases CPU time and memory bandwidth usage, particularly when feedback records are re-analyzed or used to generate multiple prompt sentences. Second, the integration of sentiment classification with structured prompt generation for a generative AI model reduces the number of necessary model invocations and limits token length, thereby reducing communication load over the network and inference time on the AI backend. Third, by programmatically encoding classification conditions and major issue information into prompt data, the server transforms raw sentiment statistics into optimized input for the generative model, which improves the precision and stability of generated measures and reduces the rate of irrelevant or incoherent outputs.

The server employs non-conventional processing sequences that differ from simple automation of human tasks. For example, the server applies a hybrid pipeline: a discriminative deep learning sentiment classifier is used to generate structured sentiment labels and confidence scores that feed an aggregation and issue extraction module. The output of this pipeline is then used not merely as human-readable reports but as machine-oriented features for constructing prompt data that controls a separate generative model. This multi-stage, model-to-model orchestration is optimized for computational efficiency and output structure, which is not feasible through manual human operations.

The server can employ variation embodiments. In one variation, the server uses a recurrent neural network or a convolutional neural network instead of a transformer-type network for sentiment classification, adjusting input feature representation accordingly. In another variation, the server integrates an additional feature extraction module that computes numeric features, such as sentence length, keyword density, or historical user behavior metrics, and feeds these features into the classification head alongside the text embeddings. The server may also adjust training hyperparameters, such as batch size, learning rate, and regularization coefficients, to optimize model performance for specific domains.

In another embodiment, the server maintains a versioned model management system in the storage unit. The server records, for each model version, training data identifiers, hyperparameter settings, and evaluation metrics. The server can dynamically select an optimal model version based on current domain conditions, such as the type of product being analyzed or the language of feedback. By controlling model selection programmatically, the server further improves accuracy and robustness of sentiment classification and, consequently, improves the quality of prompt data supplied to the generative AI model.

The described system is applicable in various real-world environments, such as large-scale online services, manufacturing quality control systems, and technical support platforms. The combination of structured text preprocessing, deep learning-based sentiment classification, programmatic prompt generation, and interactive dashboard management provides a technical framework that enhances system-level performance, reduces computational waste, and enables consistent, repeatable analysis and improvement cycles. Through these mechanisms, the server contributes to the improvement of computer technology itself, rather than merely automating a conventional human workflow.

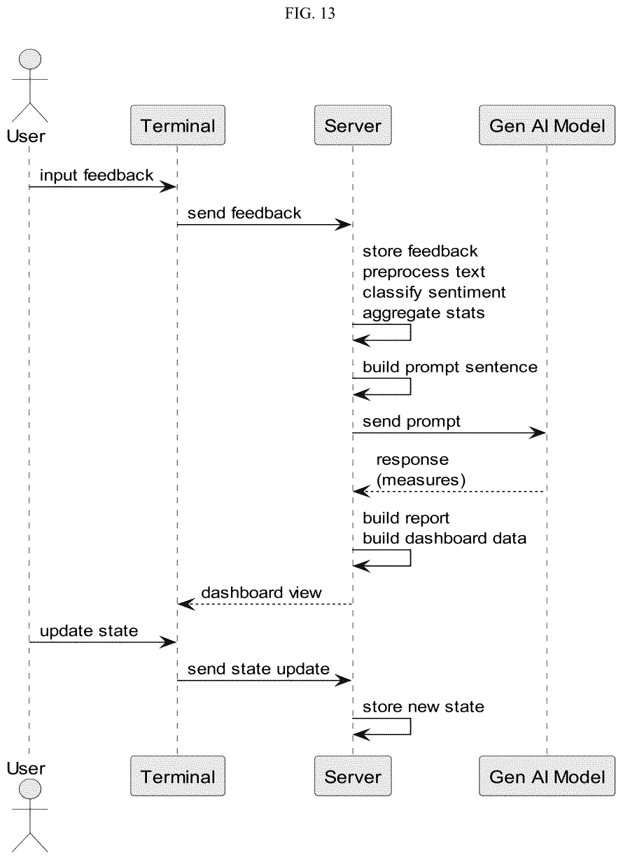

The following describes the processing flow using FIG. 13.

### Step 1

User operates the terminal to input opinion information and request information through a graphical user interface that includes text fields and rating controls.
The input of Step 1 is raw user feedback, including free-text comments such as “This app is convenient but the performance is slow,” along with optional ratings and product identifiers.
The output of Step 1 is a structured payload on the terminal, for example a data object containing fields for user ID, product ID, comment text, rating, and timestamp, ready to be transmitted to the server.

### Step 2

Terminal transmits the structured payload to the server via a network using a protocol such as HTTPS and an application interface such as a REST API.
The input of Step 2 is the structured payload generated in Step 1.
The output of Step 2 is a network request received by the server that encapsulates the feedback data in a machine-readable format, such as JSON.

### Step 3

Server receives the network request, validates the payload, and stores the opinion information and request information as structured records in a relational database.
The input of Step 3 is the JSON (or equivalent) request body containing user identifiers, product identifiers, timestamps, and comment text.
The server performs data parsing, type checking, mandatory-field verification, and creation of database records, and the output is one or more persisted rows in tables that store feedback identifiers, user identifiers, product identifiers, timestamps, and original text fields.

### Step 4

Server retrieves newly stored feedback records from the relational database and applies preprocessing using a natural language processing program.
The input of Step 4 is a set of feedback records containing raw text fields (opinion information and request information).
The server executes character string normalization (lowercasing, Unicode normalization), unnecessary symbol removal (removing decorative punctuation and markup), and function word removal (filtering domain-specific stop words), and the output is normalized analysis text data, stored as additional fields or associated records for each feedback item.

### Step 5

Server tokenizes the analysis text data and converts tokens into numerical identifiers compatible with a deep learning sentiment classification model.
The input of Step 5 is the normalized analysis text data generated in Step 4.
The server applies a tokenizer consistent with a transformer-based model, segments the text into tokens, maps each token to an integer ID, constructs attention masks, and the output is a set of input tensors (token ID sequences and attention masks) ready for sentiment inference.

### Step 6

Server executes a sentiment classification process based on a deep learning algorithm, such as a transformer-architecture neural network, to compute sentiment labels and confidence information.
The input of Step 6 is the set of input tensors representing each piece of analysis text data.
The server performs a forward pass through embedding layers, multiple self-attention layers, and a classification head, computes logits for sentiment categories, applies a softmax function to obtain probabilities, and the output is, for each feedback item, a sentiment label (positive, negative, or neutral) and corresponding confidence scores, which the server writes back to the database.

### Step 7

Server aggregates sentiment labels and confidence information into statistical information over product units, time units, and user attribute units.
The input of Step 7 is the set of database records enriched with sentiment labels and confidence scores.
The server executes grouping and aggregation operations, such as counting labels per product and computing ratios of positive and negative feedback per time interval, and the output is statistical information including sentiment distributions, trend metrics, and aggregated confidence measures stored in dedicated aggregation tables or materialized views.

### Step 8

Server derives sentiment tendency information and issue extraction information from the statistical information and the underlying analysis text data.
The input of Step 8 is aggregated statistical information and linked analysis text data for each group.
The server identifies patterns such as spikes in negative feedback, computes metrics such as rate-of-change in sentiment, and applies text analysis techniques (e.g., term frequency analysis or clustering) to extract representative issues, and the output is structured data describing sentiment tendencies and major issues per product, period, or user segment.

### Step 9

Server generates analysis result information by combining sentiment tendency information, issue extraction information, and representative opinion information and request information into a unified internal data structure.
The input of Step 9 is the sentiment tendencies, extracted issues, and corresponding feedback samples selected from the database.
The server selects example comments for each major issue, associates them with aggregated metrics, and composes a structured object that encapsulates, for each logical grouping, issue identifiers, statistics, and example texts, and the output is the analysis result information that serves as a basis for generating prompt data.

### Step 10

Server constructs prompt data defining a prompt sentence for a generative AI model by programmatically formatting the analysis result information into natural language instructions.
The input of Step 10 is the analysis result information, including classification condition information (such as product category or performance-related issues) and major issue information (such as “slow screen loading” or “frequent errors”).
The server inserts these elements into prompt templates, such as:
“Given the following customer feedback comments about our mobile app, group them into categories (e.g., startup speed, screen loading, crashes, usability) and summarize the main issues in each category. Then propose specific technical or design improvements. Feedback list: [list of comments].”
or
“Based on the feedback received in the last 30 days about our service, identify the top three causes of user dissatisfaction and the top three strengths. For each cause of dissatisfaction, propose at least two actionable improvement measures that a product team can implement.”
The output of Step 10 is prompt data that includes at least one prompt sentence and any associated control parameters (such as requested number of categories or number of measures per issue).

### Step 11

Server transmits the prompt data to a generative AI model via an inference API and receives response information from the model.
The input of Step 11 is the prompt data generated in Step 10.
The server sends the prompt sentence and model configuration parameters (such as maximum output length and sampling temperature) to the generative AI model, waits for completion of text generation, and the output is response information in natural language, including improvement measure descriptions, suggested groupings of issues, and marketing strategies formatted according to the prompt.

### Step 12

Server parses and structures the response information, associating each generated improvement measure and marketing measure with one or more logical issue groups.
The input of Step 12 is the free-text response from the generative AI model and the corresponding prompt context used to generate it.
The server applies rule-based parsing or pattern matching, identifies segments corresponding to each issue category, extracts measure descriptions, and maps them back to the internal identifiers of issue groups, and the output is structured improvement measure information and marketing measure information stored in dedicated tables linked to the analysis result information.

### Step 13

Server reconstructs report information by combining structured improvement measures, marketing measures, and statistical information for each logical issue group.
The input of Step 13 is the structured improvement and marketing measures from Step 12 and the statistical/issue data from Steps 7 and 8.
The server creates composite data objects that include, for each group, aggregated sentiment metrics, example feedback texts, proposed actions, and identifiers for tracking execution state, and the output is report information formatted for visualization and state management.

### Step 14

Server generates visualization screen data and display control information for presenting the report information in a dashboard format on the terminal.
The input of Step 14 is the report information from Step 13.
The server maps each metric and item to graphical elements, such as bar charts, line graphs, and tables, defines layout parameters, and constructs a response that includes chart specifications, text panels, and interaction metadata; the output is display control information that instructs the terminal how to draw the dashboard and how to attach interactive controls for each improvement and marketing measure.

### Step 15

Terminal renders the dashboard using the display control information and allows the user to interact with execution state controls for improvement measures and marketing measures.
The input of Step 15 is the display control information received from the server.
The terminal draws graphs, lists, and buttons, binds user interface events (such as clicks or selections) to specific measures, and the output is an interactive visualization screen in which the user can view analysis results and update execution states.

### Step 16

User operates the terminal to change execution state information for selected improvement measures and marketing measures based on the displayed analysis results.
The input of Step 16 is the interactive dashboard view showing each measure and its current execution state.
The user selects one or more measures and assigns states such as “planned,” “in progress,” or “completed,” and the output is a set of updated execution state values transmitted from the terminal to the server as an update payload.

### Step 17

Server receives the update payload and stores updated execution state information in the relational database in association with corresponding measures and report information.
The input of Step 17 is the state update payload identifying measures and new execution states.
The server validates the updates, writes new state values into execution-state fields, maintains versioning or timestamps as needed, and the output is a persistent record of current execution states linked to the analytical and generative results, enabling future retrieval, comparison, and further prompt generation based on implementation progress.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented feedback analysis systems mainly treat user feedback as unstructured text that is processed in a batch, offline manner. Such systems typically perform isolated sentiment scoring and keyword counting, without consistently linking low-level emotion analysis to high-level strategy generation in a closed feedback loop. As a result, several technical problems arise in the operation of information processing apparatuses and networks.

First, existing architectures do not integrate natural language preprocessing, emotion estimation, structured aggregation, prompt generation, and generative AI invocation into a single coordinated pipeline controlled by a processor. Because these stages are loosely coupled or executed manually, the processor cannot efficiently reuse intermediate analysis results or automatically adapt processing parameters based on evolving feedback. This leads to increased computation overhead, latency in updating strategies, and duplicated processing of the same feedback data.

Second, many systems merely pass raw or minimally processed text to a generative AI model. In such cases, the generative model must internally perform heavy analysis each time a request is received, without being guided by structured, machine-readable index information derived from prior computation. This results in unstable output quality, inconsistent use of sentiment and aspect information, and inefficient utilization of computing resources in both the local apparatus and remote AI infrastructure. There is no mechanism at the processor level for automatically constructing optimized prompt sentences that embed precomputed emotion labels, aggregated evaluation elements, and operation conditions to guide the generative AI model toward reproducible and targeted outputs.

Third, existing solutions rarely provide a native, system-level loop that feeds user reactions to AI-generated measures back into the same analysis and generation pipeline. User constraints, such as budget limits or prioritization of certain product features, are often handled outside the core processing logic, by manual tuning or ad-hoc configuration. Consequently, the processor cannot systematically incorporate user constraints as structured input into subsequent prompt sentences, and cannot automatically adjust the generative AI model's behavior based on these constraints. This prevents the system from converging, over time, toward measures that are simultaneously aligned with customer emotions and explicit business requirements.

Fourth, visualization of analysis results and AI-generated measures is often implemented as a thin layer over raw text responses, without using structured associations between measures, emotion labels, and index information. Without such structured associations, it is difficult for the processor to generate dashboard-type visualization data that can be efficiently rendered by a client device. This limits the ability of users to quickly understand which feedback clusters and emotion patterns led to particular measures and impairs the usability and performance of client-server communication.

Therefore, there is a need for an improved computer-implemented system that: (i) integrates natural language preprocessing and emotion classification with structured aggregation of evaluation elements and improvement request elements; (ii) automatically generates prompt sentences embedding such analysis results and operation conditions to guide a generative AI model; (iii) establishes a loop in which additional user evaluation and constraint information are fed back into the prompt generation and measure regeneration; and (iv) produces structured visualization data that directly links generated measures with underlying emotion and index information. Such an integrated design can improve the efficiency, stability, and responsiveness of the overall information processing performed by the processor and the associated computing infrastructure.

The specific processing by the specific processing unit 290 of the data processing device 12 in Application Example 2 is realized by the following means.

The present invention provides a server comprising a processor configured to perform input/output processing to obtain evaluation information from a user; to store the obtained evaluation information in a storage device and to preprocess the evaluation information by natural language processing, including at least word segmentation, removal of non-informative terms, and normalization of word forms; to execute an emotion estimation model on the preprocessed evaluation information to perform emotion classification processing and to calculate, for each piece of evaluation information, a plurality of emotion labels and a confidence value for each emotion label; to extract, based on the emotion labels, positive evaluation elements and improvement request elements for each target item or target service, to aggregate the elements, and to store the aggregated elements as index information in association with the target item or the target service in the storage device; to automatically generate a prompt sentence for input to a generative AI model based on the index information and the emotion labels contained in analysis results, and to embed the analysis results and operation conditions into the prompt sentence so as to guide the generative AI model to generate optimized improvement measures or action measures; to store, in the storage device, the improvement measures or the action measures output from the generative AI model and to provide the improvement measures or the action measures as visualization information to the input/output processing; and to obtain additional evaluation information or constraint condition information from the user with respect to the improvement measures or the action measures, and to execute loop processing in which the additional evaluation information or the constraint condition information is reflected in the prompt sentence and the generative AI model is caused to regenerate or adjust the measures. This enables the processor to implement an integrated, closed-loop computation pipeline that (i) converts unstructured user feedback into structured emotion-aware index information, (ii) systematically guides a generative AI model via automatically constructed prompt sentences embedding such information and operation conditions, (iii) iteratively refines generated measures in response to further user input, and (iv) outputs structured visualization data linking measures with underlying emotion and index information, thereby improving the efficiency, consistency, and responsiveness of computer-based feedback analysis and strategy generation.

The term “evaluation information” refers to information representing an opinion, assessment, preference, request, or requirement provided by a user with respect to a target item or a target service, and including at least natural language text data and optionally numerical ratings or categorical selections.

The term “input/output processing” refers to processing performed by the processor to receive data from an external device or user interface and to transmit data or display information to the external device or user interface, including at least receiving feedback input and providing visualization information.

The term “storage device” refers to a hardware or virtual component configured to store data under control of the processor, including at least non-volatile memory, volatile memory, or a combination thereof, such as a database system, a file system, or a key-value store.

The term “natural language processing” refers to processing in which the processor analyzes text expressed in a human language to transform the text into a representation suitable for computation, and includes at least word segmentation, removal of non-informative terms, normalization of word forms, and optionally lemmatization, stemming, part-of-speech tagging, or syntactic parsing.

The term “word segmentation” refers to processing in which a continuous text string is divided into units such as words, tokens, or phrases based on language-dependent rules or models.

The term “removal of non-informative terms” refers to processing in which words or tokens that contribute little to semantic or sentiment analysis, such as function words, common stop words, or noise symbols, are removed from the text.

The term “normalization of word forms” refers to processing in which multiple surface forms of a word are converted into a unified representation, such as converting inflected forms to a base form, converting uppercase characters to lowercase characters, or applying lemmatization or stemming.

The term “emotion estimation model” refers to a computational model, implemented in software, hardware, or a combination thereof, configured to receive preprocessed text as input and output one or more emotion labels and associated confidence values, using at least statistical methods, machine learning methods, or neural network methods.

The term “emotion classification processing” refers to processing in which the emotion estimation model assigns one or more emotion labels, such as positive, negative, neutral, or other categories, to a piece of evaluation information and calculates, for each label, a confidence value indicating a degree of likelihood.

The term “emotion label” refers to a symbolic representation of an estimated emotional state contained in evaluation information, including at least categories such as positive, negative, neutral, satisfaction, or dissatisfaction.

The term “confidence value” refers to a numerical value output by the emotion estimation model indicating a probability, score, or reliability associated with a corresponding emotion label.

The term “target item” refers to an object that is the subject of evaluation information, including at least a product, a component, a content item, or another tangible or intangible object.

The term “target service” refers to a service that is the subject of evaluation information, including at least a provided function, an operation, a transaction, or an online or offline service.

The term “positive evaluation element” refers to an extracted feature, aspect, or attribute of a target item or a target service that is associated with an emotion label indicating a favorable or positive sentiment in the evaluation information.

The term “improvement request element” refers to an extracted feature, aspect, or attribute of a target item or a target service that is associated with an emotion label indicating an unfavorable, negative, or unsatisfied sentiment in the evaluation information, and that suggests a need for change or improvement.

The term “aggregation” refers to processing in which multiple positive evaluation elements or improvement request elements are combined, counted, summarized, or grouped according to one or more keys such as a target item, a target service, an attribute, or a time period.

The term “index information” refers to structured information generated by aggregating positive evaluation elements and improvement request elements, and representing metrics, indicators, or summary values associated with a target item or a target service.

The term “analysis results” refers to information produced by one or more processing stages applied to evaluation information, including at least emotion labels, confidence values, positive evaluation elements, improvement request elements, and index information.

The term “operation conditions” refers to parameters, constraints, or context information used to control behavior of the generative AI model or the system, including at least budget limits, target user segments, time periods, or priority levels.

The term “generative AI model” refers to a computational model configured to generate text or other data based on an input prompt sentence, using at least a machine learning architecture that has been trained on example data, and capable of producing improvement measures, action measures, or other proposals.

The term “prompt sentence” refers to a sequence of symbols or text provided as input to the generative AI model, the content of which instructs, constrains, or guides the generative AI model to generate a desired type of output.

The term “optimized improvement measure” refers to a measure generated by the generative AI model that specifies a modification, correction, or enhancement to a target item or a target service, wherein the measure is generated based on analysis results and operation conditions so as to improve alignment with user emotions and constraints.

The term “action measure” refers to a proposed action, plan, or strategy generated by the generative AI model for operating, promoting, or managing a target item or a target service.

The term “visualization information” refers to data structured for presentation on a display device, including at least textual summaries, numerical values, and graphical data, enabling a user to visually understand relationships between evaluation information, emotion labels, index information, and generated measures.

The term “additional evaluation information” refers to new or supplemental evaluation information provided by a user with respect to previously generated improvement measures or action measures, including textual feedback, ratings, or comments.

The term “constraint condition information” refers to information specifying a limitation or requirement that should be considered when generating or adjusting improvement measures or action measures, such as cost constraints, time constraints, or resource constraints.

The term “loop processing” refers to processing in which a series of operations, including obtaining additional evaluation information or constraint condition information, regenerating or adjusting a prompt sentence, invoking the generative AI model, and updating measures, is repeatedly executed under control of the processor.

The term “structured data” refers to data organized according to a predefined format, schema, or data model, in which relationships between improvement measures, action measures, emotion labels, and index information are explicitly represented in machine-readable form.

The term “display data” refers to data prepared for rendering by a display device, including layout information, component values, and graphical elements, derived from structured data.

The term “dashboard-type screen” refers to a display layout comprising multiple visual components, such as charts, tables, and textual panels, that are arranged to simultaneously present, on a single screen or related screens, summaries of evaluation information, emotion analysis, index information, and generated measures.

In one embodiment, a server includes a processor, a main memory, a non-volatile storage device, and a network interface. The server is connected via a communication network to one or more terminals. The terminal includes at least a display device, an input device, a local memory, and a communication interface. The user operates the terminal to input evaluation information and to view visualization information provided by the server.

The server executes an operating system and one or more application programs that implement the functions described in the claims. The server uses a database management system, such as a relational database engine, as the storage device. The storage device stores, in different tables, evaluation information, preprocessed text, emotion labels and confidence values, index information, generated prompt sentences, outputs of a generative AI model, and visualization-oriented structured data.

The server implements natural language processing by executing program modules written in a general-purpose programming language and using general-purpose natural language processing libraries such as tokenization libraries, morphological analyzers, and syntactic parsers. The server performs data processing including word segmentation, removal of non-informative terms, normalization of word forms, and optional lemmatization or stemming.

The server uses structured data containers, such as row-based records or column-based vectors, to represent token sequences, part-of-speech tags, and syntactic dependencies. The server writes these representations into specific columns in database tables so that they can be reused without repeating the same computation.

The server implements an emotion estimation model as a neural-network-based classifier. In one embodiment, the emotion estimation model is a transformer-based neural network having an embedding layer, a plurality of self-attention layers, and a classification head. The embedding layer maps each token index into a continuous-valued vector. The self-attention layers compute attention scores between tokens, using query, key, and value matrices, and propagate contextualized representations along the token sequence. The classification head applies one or more fully connected layers to the aggregated token representation, followed by a softmax activation to output class probabilities for emotion labels such as positive, negative, neutral, satisfaction, or dissatisfaction.

The server trains the emotion estimation model in advance using a large set of labeled evaluation information. The server defines a loss function such as cross-entropy between the predicted emotion distribution and the ground-truth label distribution. The server updates model parameters by a gradient-based optimization algorithm such as stochastic gradient descent or an adaptive learning-rate method. The server may apply regularization techniques such as dropout, weight decay, or batch normalization. The server may also perform data augmentation by paraphrasing training sentences, injecting noise into word order, or replacing words with synonyms to improve robustness. By performing this training, the server obtains model parameters that map preprocessed text into reliable emotion labels and associated confidence values.

The server processes evaluation information by first converting each feedback text into a fixed-length vector representation using the emotion estimation model. The server then reads the output probability distribution over emotion labels and selects labels whose probability exceeds a predetermined threshold as valid emotion labels. The server records, for each piece of evaluation information, the selected emotion labels and their confidence values in an emotion table. This explicit recording of labels and confidence values reduces repeated computation because subsequent processes need not invoke the neural network again.

The server extracts positive evaluation elements and improvement request elements by combining the emotion labels with aspect information. The server identifies aspects by applying noun phrase extraction, dependency parsing, or domain-specific keyword dictionaries to the preprocessed text. For each evaluation information record, the server associates phrases representing attributes, such as “battery life,” “delivery speed,” or “ease of use,” with the corresponding emotion labels. When a phrase is associated with a positive label, the server records the phrase as a positive evaluation element. When a phrase is associated with a negative or dissatisfaction label, the server records the phrase as an improvement request element. The server stores these elements in an element table that has fields including a target item identifier, a target service identifier, an aspect string, an emotion label, and a timestamp.

The server aggregates elements into index information by executing group-based aggregation algorithms. The server groups records by target item or target service and by aspect, and computes counts, ratios, and time-based trends of positive evaluation elements and improvement request elements. The server stores the aggregated metrics in an index table. The index table contains, for each item or service, fields such as a total number of positive mentions for an aspect, a total number of negative mentions for an aspect, an average sentiment score over a period, and a change rate compared to a previous period. This structured aggregation allows the server to access summarized emotion-aware metrics without scanning raw text, thereby improving computation efficiency and reducing storage I/O.

The server generates a prompt sentence for a generative AI model using both index information and emotion labels. The server uses a prompt generation module that takes, as input, the target item or service identifier, associated index records, and optional operation conditions such as budget, timeframe, or target user segment. The server formats the prompt sentence according to a predefined template. For example, the server generates a prompt sentence such as:
“Analyze the following summarized customer feedback and propose concrete improvement measures and a marketing strategy.
Product: X100.
Positive points: easy to use, attractive design.
Improvement points: short battery life, slow delivery.
Please output: (1) three improvement actions, and (2) a promotion message for young customers.”

The server may generate other prompt sentences including operation conditions, such as:
“The current proposal is: ‘Run a social media campaign targeting customers in their 20s with a 20% discount.’

The user feedback is: ‘This proposal is good, but please reduce the discount rate because of our budget limit.’

Adjust the promotion plan to respect the budget constraint and keep it attractive for customers in their 20s.”

The server may generate a prompt sentence for generating a product page summary such as:
“From the following customer review, generate one short sentence that summarizes satisfaction points and improvement points for display on the product page:
‘This product is very good. I like the design, but the delivery was slow.’”

The server configures the generative AI model, which may be a large language model, with parameters including maximum output length, sampling temperature, and top-k or top-p sampling parameters. The server sends the prompt sentence and configuration parameters through the network interface to a generative AI inference engine. The server may run the generative AI model locally using a neural network library or may access a remote generative AI service. In either case, the generative AI model internally processes the prompt sentence through transformer layers or another sequence-to-sequence architecture and produces output tokens representing improvement measures or action measures.

The server receives the output tokens and combines them into an output text. The server associates each output text with the underlying prompt sentence and the relevant index information by assigning a strategy identifier. The server records the generated output in a strategy table that contains fields such as the strategy identifier, target item or service identifier, timestamp, and full text of the proposed measures. The server also records metadata such as model version, generation parameters, and input prompt identifier. This structured storage enables subsequent traceability and reproducibility of generated strategies.

The server generates visualization information by constructing structured data objects that combine index information, emotion labels, and generated measures. The server generates data structures such as JSON-like objects or relational records that specify, for each element to be displayed on a dashboard, the associated metric values, labels, and textual explanations.

The server converts these structures into display data that can be easily rendered at the terminal. For example, the server may define a chart configuration that maps the count of positive evaluation elements for each aspect to a bar chart and maps the count of improvement request elements to another bar chart, and also associates each bar with a list of generated improvement measures.

The terminal receives the structured visualization information from the server via the communication network. The terminal executes a visualization application that interprets the structure and draws graphical components, such as charts, tables, and text panels, on the display device. The terminal presents the user with a dashboard-type screen that shows relationships between evaluation information, dominant emotion labels, index metrics, and generated improvement measures. Because the server already aggregates and structures the data, the terminal can render the dashboard using simple operations, which reduces processing load on the terminal and improves responsiveness for the user.

The server obtains additional evaluation information or constraint condition information from the user with respect to the generated improvement measures or action measures. The user operates the terminal to enter comments and constraints in a dedicated input area of the dashboard, for example: “This plan is good, but please reduce the discount rate due to budget constraints.” The terminal transmits the comment and context information, including the strategy identifier, to the server. The server parses the comment using the same natural language processing pipeline to extract constraints and attitudes toward the proposed measures. The server may treat the new comment as evaluation information of a special class tied to strategies rather than products.

The server incorporates the extracted constraints and evaluation into a new prompt sentence. The server uses a second template that includes the previous strategy text, the user's comment, and relevant index information. The server generates a new prompt sentence that instructs the generative AI model to revise the plan under the given constraints. Because the server uses structured index information and emotion labels instead of raw text only, the prompt sentence can be constructed in a consistent and compact form. This reduces the length of input text to the generative AI model and thereby reduces communication and computation load while keeping relevant context explicit.

The server then invokes the generative AI model again with the revised prompt sentence. The generative AI model produces an adjusted set of improvement measures or action measures. The server stores the adjusted measures as a new strategy version in the strategy table and updates the visualization information so that the terminal can display both the original and adjusted measures for comparison. The user can repeatedly provide new constraints or evaluations, and the server executes loop processing that continues updating prompt sentences and regenerating measures. Because this loop is implemented in a structured manner within the server, the system is capable of converging toward measures that satisfy both emotion-based insights and explicit constraints.

In this configuration, the server does not merely automate human reading of feedback. The server imposes a particular data structure and pipeline: emotion labels and aspects are calculated once and stored as indexed fields; aggregation is performed into index tables; prompt sentences explicitly embed these machine-readable metrics; and generated outputs are stored with links back to underlying metrics. This data structure allows the server to perform selective recomputation and partial updates. For example, when new evaluation information arrives for an item, the server can update only the relevant index records and regenerate only prompt sentences and measures for that item, without reprocessing unrelated items. This targeted recalculation improves computing efficiency and reduces server-side load.

Furthermore, the use of structured prompt generation and loop processing yields technical improvements over naive approaches that send full raw feedback texts to a generative AI model for every request. By using precomputed index information and emotion labels, the server reduces the amount of textual data that must be transmitted to and processed by the generative AI model. This reduction in input size lowers communication bandwidth usage and model inference latency. In addition, because the prompt structure is stable and guided by machine-computed metrics, the output of the generative AI model is more deterministic and easier to compare over time, which improves the reliability of the system.

In another embodiment, the server modifies the architecture of the emotion estimation model and generative AI interface to further improve computation efficiency. The server may implement the emotion estimation model as a compact neural network with fewer layers and reduced hidden dimension, and may offload the heavier generative AI model to a remote inference service. The server computes emotion labels locally and sends only compressed index information and minimal textual context to the remote generative AI service. This partitioning reduces the amount of raw data transferred over the network and allows the local server to operate with lower latency. The causality between this architecture and the technical effect is that the system uses specialized local models for classification and remote models for generation, which together reduce network traffic and improve responsiveness of end-to-end processing.

In another embodiment, the server employs a rule-based post-processing module that operates after the generative AI model produces measures. The server checks the generated text against operation conditions stored in the storage device. For example, if a cost-related constraint or regulatory rule is violated by the generated measure, the server marks the measure as invalid and may automatically request the generative AI model to generate an alternative. The server may encode such rules as a decision tree or a set of logical conditions, which is different from human judgment and ensures consistent enforcement of constraints. This non-conventional combination of statistical generation and rule-based filtering improves the quality and safety of generated measures and is realized through explicit data processing within the server.

In another embodiment, the server uses reinforcement learning methods to adjust parameters of the prompt generation module. The server records user-confirmed measures as positive outcomes and user-rejected measures as negative outcomes. The server treats these outcomes as rewards and updates policy parameters used to select which index information to include or emphasize in a prompt sentence. The server may implement a bandit algorithm or policy gradient method over a discretized prompt-configuration space. Through this mechanism, the server learns to generate prompt sentences that produce measures more likely to be accepted by users, thereby improving long-term system performance. This kind of learning modifies how the server assembles technical inputs to the generative AI model, rather than directly modifying business content.

In another embodiment, the terminal is implemented as a portable communication device. The terminal reduces local computation by delegating heavy processing tasks to the server. The terminal maintains only lightweight display logic and input control logic. Because the server already structures visualization information with precomputed layouts and components, the terminal can render complex dashboards with minimal CPU and memory usage. This contributes to lower energy consumption and improved battery life for the terminal.

In another embodiment, the server applies compression or batch-processing to data transmitted between the server and the generative AI module. The server may compress prompt sentences and generated outputs using text compression algorithms prior to transmission and decompress them after reception. The server may also combine multiple prompt sentences for different items into a single batched request to the generative AI model and decompose the response accordingly. These techniques reduce the number of network round-trips and amount of transmitted data, bringing a measurable reduction in communication overhead.

In all of these embodiments, the server, terminal, and user operate together in a manner that goes beyond simply automating human decision-making. The server defines and applies specific data structures, model architectures, and algorithmic flows that exploit intermediate computational results and optimize runtime behavior of the overall system. Because the system's performance improvements, such as faster update cycles, lower communication load, improved emotion classification accuracy, and more stable generative outputs, result from the technical configuration of the server and models, the invention provides a concrete technological improvement in computer-based processing of evaluation information and in the control and utilization of generative AI models through structured prompt sentences.

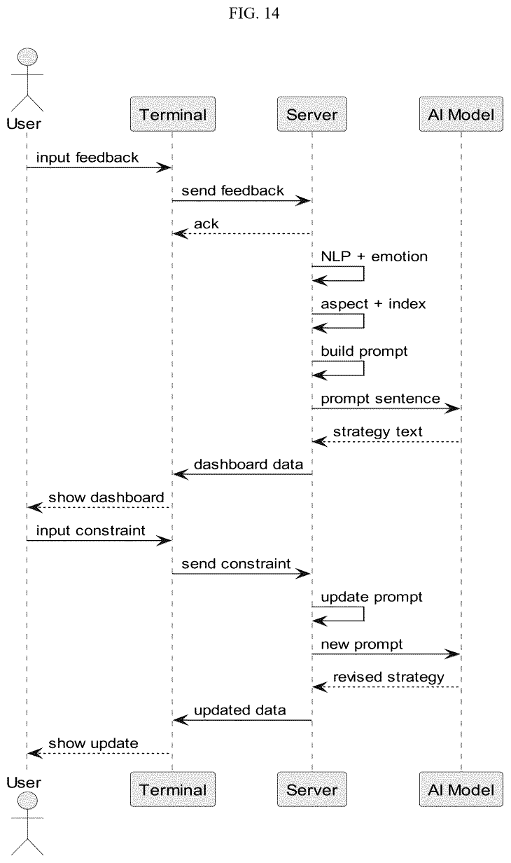

The following describes the processing flow using FIG. 14.

### Step 1

User operates the terminal to input evaluation information.
User enters text such as “This product is very easy to use, but the battery life is poor” into a text field and optionally selects a rating value.
Input: natural language text and optional rating from the user.
Terminal converts the input into a structured message including fields such as ‘user_id’, ‘item_id’, ‘text’, and ‘rating’.
Terminal sends this structured message to the server via an HTTP request over a network connection.
Output: structured feedback data transmitted from the terminal to the server.

### Step 2

Server receives the structured feedback data from the terminal.
Server validates the data format, checks mandatory fields, and assigns a unique feedback identifier.
Input: structured feedback message from the terminal.
Server writes a new record into a feedback table in a storage device, storing fields such as feedback ID, user ID, item ID, raw text, rating, and timestamp.
Server returns an acknowledgement response to the terminal indicating successful storage.
Output: persistent feedback record stored in the storage device and an acknowledgement to the terminal.

### Step 3

Server retrieves unprocessed feedback records from the feedback table.
Server selects records whose preprocessing flag indicates “not processed.”
Input: raw feedback records from the feedback table.
Server applies natural language processing to each feedback text: the server tokenizes the text into words, removes non-informative terms such as stop words, normalizes word forms by lowercasing and optional lemmatization, and stores the resulting token sequence.
Server updates each feedback record with a preprocessed text field and sets a preprocessing flag to “processed.”
Output: preprocessed feedback records with normalized token sequences stored in the storage device.

### Step 4

Server executes the emotion estimation model on the preprocessed feedback.
Input: preprocessed token sequences for each feedback record.
Server transforms each token sequence into numerical indices, looks up embedding vectors, and feeds the sequence into a neural network classifier that includes attention layers and a classification layer. The classifier computes a probability distribution over predefined emotion labels (for example, positive, negative, neutral, satisfaction, dissatisfaction).
Server selects the top emotion labels whose probabilities exceed a threshold and records their associated confidence values.
Server creates or updates entries in an emotion table linking each feedback ID with one or more emotion labels and confidence values.
Output: emotion-labeled feedback data with confidence scores stored in the emotion table.

### Step 5

Server extracts aspect phrases and associates them with emotion labels.
Input: preprocessed feedback text and corresponding emotion labels from the feedback and emotion tables.
Server uses syntactic parsing or phrase extraction to identify aspect phrases such as “battery life,” “delivery,” or “ease of use” from each feedback text.
Server assigns each aspect phrase the emotion label associated with the same feedback record, distinguishing between positive evaluation elements and improvement request elements based on whether the emotion label is positive or negative.
Server writes aspect-element records into an element table, including fields such as item ID, aspect phrase, emotion type, and timestamp.
Output: structured aspect-level elements classified into positive evaluation elements and improvement request elements.

### Step 6

Server aggregates elements to generate index information.
Input: aspect-level element records from the element table.
Server groups records by item ID and aspect phrase, counts the number of positive evaluation elements and improvement request elements, and calculates ratios or trend metrics over time.
Server writes aggregated metrics into an index table, including, for each item and aspect, counts of positive and negative mentions and aggregate sentiment scores.
Output: index information representing summarized emotion-aware metrics per item and aspect stored in the index table.

### Step 7

Server generates a prompt sentence for a generative AI model based on analysis results.
Input: index information, emotion labels, and optional operation conditions such as budget or target segment from the storage device.
Server selects relevant aspects and metrics for a target item or service, formats them into human-readable bullet points, and inserts them into a textual template to form a prompt sentence.
Server may generate, for example, the following prompt sentence:
“Analyze the following summarized customer feedback and propose concrete improvement measures and a marketing strategy.
Product: X100.
Positive points: easy to use, attractive design.
Improvement points: short battery life, slow delivery.
Please output: (1) three improvement actions, and (2) a promotion message for young customers.”
Output: a fully constructed prompt sentence containing structured analysis results and operation conditions.

### Step 8

Server invokes the generative AI model using the prompt sentence.
Input: prompt sentence generated in Step 7 and configuration parameters such as maximum output length and sampling settings.
Server sends a request containing the prompt sentence to a generative AI model endpoint via a network interface or executes a local inference engine using the same prompt sentence.
Server receives a generated text output from the generative AI model that specifies improvement measures or action measures.
Server stores the generated text in a strategy table along with the prompt sentence, item ID, emotion summary, and model metadata.
Output: generated strategy records including improvement measures and action measures associated with underlying analysis results.

### Step 9

Server prepares visualization data linking strategies with emotion and index information.
Input: strategy records from the strategy table, index information from the index table, and emotion labels from the emotion table.
Server constructs structured visualization objects that include chart data (for example, counts of positive and negative aspects), lists of key aspects, and text of generated measures.
Server generates display-oriented data structures specifying component types (for example, bar charts, tables, description blocks), axis values, legends, and associated strategy identifiers.
Output: visualization data describing dashboard components and their values, ready to be transmitted to the terminal.

### Step 10

Terminal requests visualization data from the server and displays a dashboard.
Input: visualization data transmitted by the server.
Terminal parses the structured visualization data, creates graphical components such as charts and tables, and renders them on the display device.
Terminal shows, in a single screen, metrics such as the number of positive mentions per aspect, the number of improvement requests per aspect, and the corresponding improvement measures generated by the generative AI model.
Output: a dashboard-type screen presenting combined emotion analysis and strategy information to the user.

### Step 11

User evaluates the displayed strategy and enters additional evaluation or constraint information.
Input: dashboard content displayed on the terminal.
User reads the generated measures and types comments such as “This proposal is good, but please reduce the discount rate because of our budget limit” into an input field on the terminal.
Terminal packages the comment together with the associated strategy identifier and sends the data to the server.
Output: structured user feedback on strategies transmitted from the terminal to the server.

### Step 12

Server incorporates user feedback into a revised prompt sentence and regenerates measures.
Input: user feedback on strategies, the corresponding strategy record, and the original analysis results.
Server preprocesses the user's comment with the same natural language processing pipeline to detect constraint terms such as “budget limit” and attitude indicators such as “good.”
Server constructs a new prompt sentence that includes both the previous strategy text and the extracted constraints, for example:
“The current proposal is: ‘Run a social media campaign targeting customers in their 20s with a 20% discount.’
The user feedback is: ‘This proposal is good, but please reduce the discount rate because of our budget limit.’
Adjust the promotion plan to respect the budget constraint and keep it attractive for customers in their 20s.”
Server sends the revised prompt sentence to the generative AI model and receives an updated set of improvement measures or action measures.
Server stores the updated measures as a new strategy version and updates visualization data so that the terminal can display both versions.
Output: revised strategy records that incorporate user constraints and updated visualization data for further presentation to the user.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

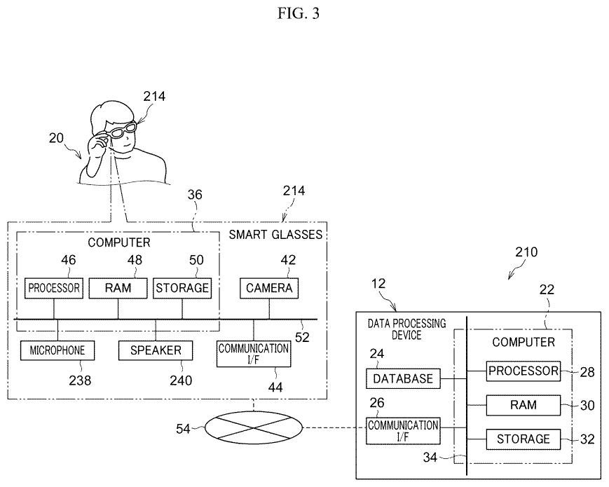

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

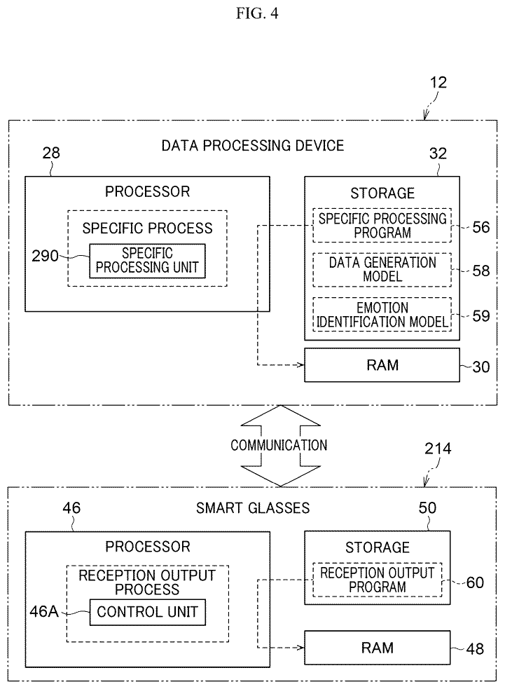

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

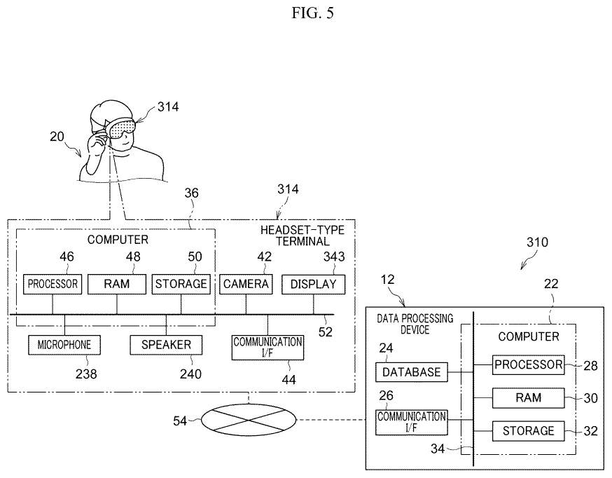

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

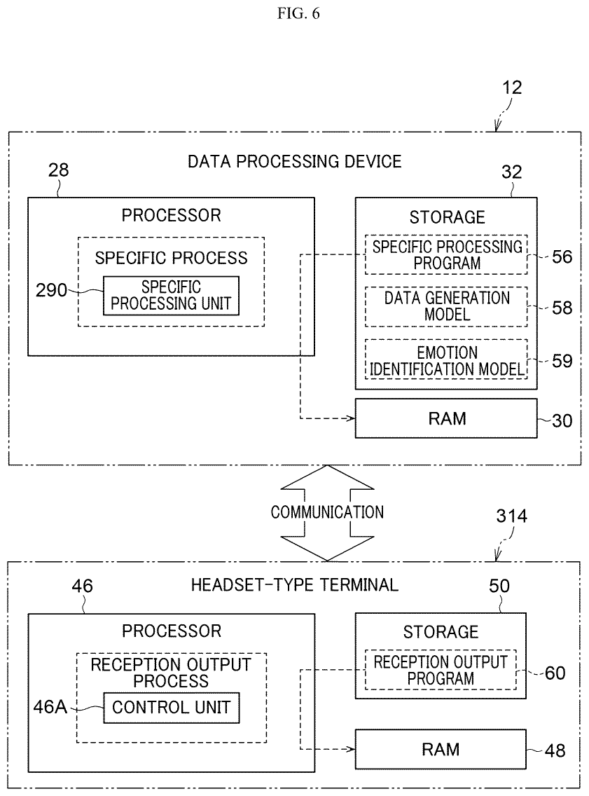

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

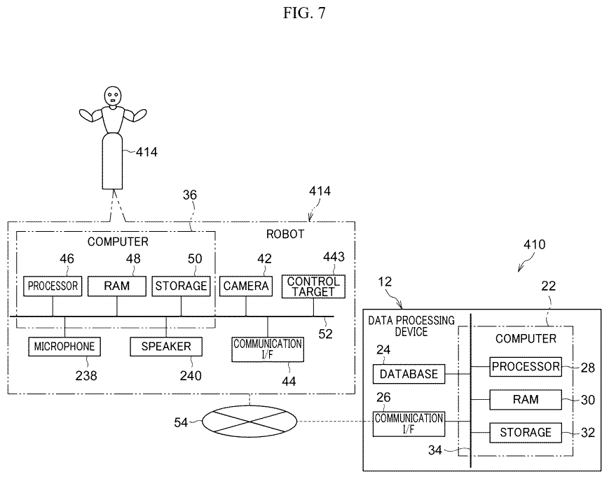

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

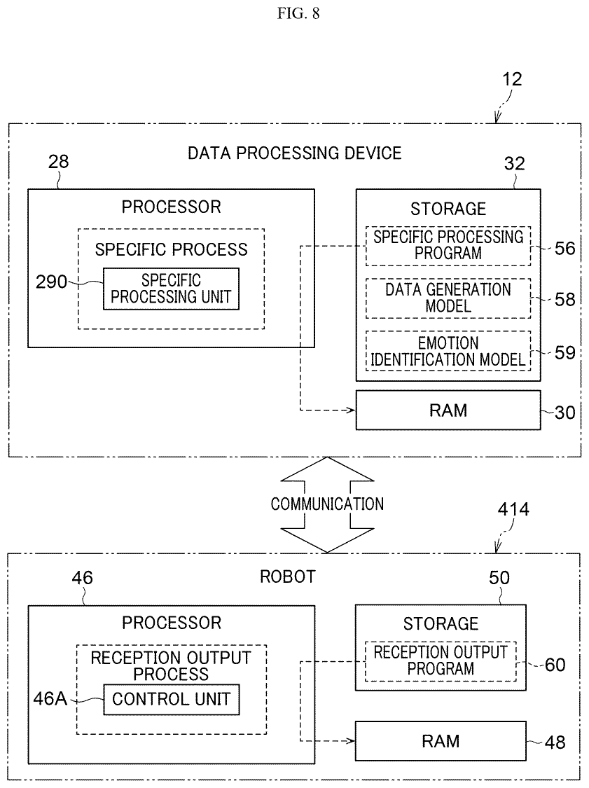

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

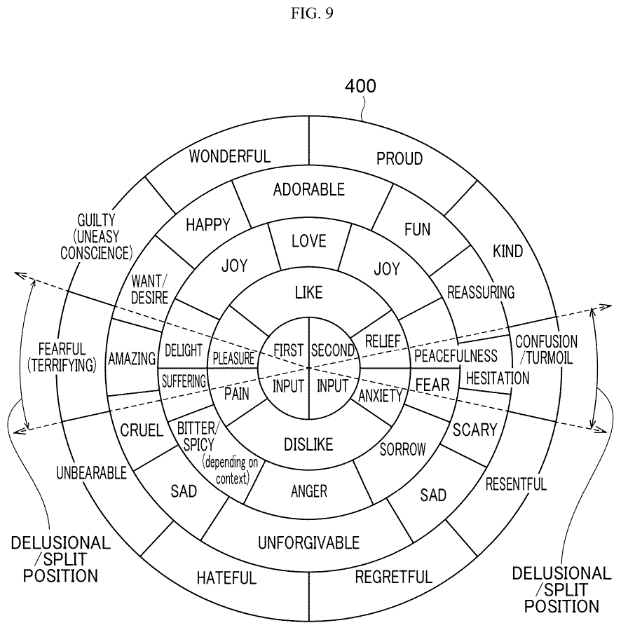

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

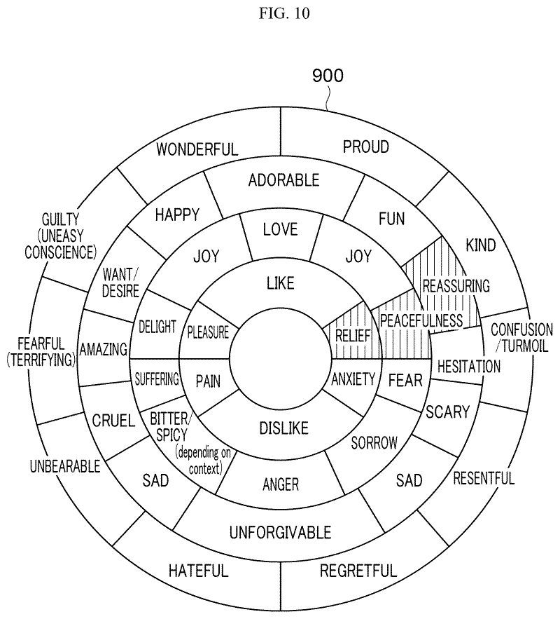

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
generate, by using a markup language and a control language, an interactive display screen and transmit the interactive display screen to a terminal device so as to provide a screen layout that enables a user to input an opinion and selection information,
receive, from the terminal device, text information and selection information that have been input on the interactive display screen by event detection processing, and transmit the text information and the selection information to the processor via a communication path,
structure the received text information and selection information and store the structured text information and selection information in a relational data structure in a storage device by control using a query language, and execute natural language processing on the text information, the natural language processing including preprocessing, aggregation processing, and feature extraction processing,
generate a prompt sentence by combining generation conditions including a summary of an analysis result obtained by the natural language processing, extraction of representative examples, and specification of an output format, and transmit inquiry data including the prompt sentence to a generative information processing model, and
acquire proposal information in a natural language output as a response from the generative information processing model, perform post-processing on the proposal information to convert the proposal information into a predetermined structure, store the proposal information in association with the relational data structure, and manage the proposal information as an improvement plan or a measure plan displayable to the user.

### Supplementary 2

The system according to supplementary 1,
wherein the processor is configured to
extract, by using a query language, a plurality of pieces of the text information and the selection information stored in the relational data structure, group extraction results by performing classification processing or aggregation processing, generate a prompt sentence including a grouping result, and guide the generative information processing model to automatically derive a related sales measure or planning policy.

### Supplementary 3

The system according to supplementary 1,
wherein the processor is configured to
execute summarization processing, priority determination processing, and visualization data conversion processing on the proposal information acquired from the generative information processing model, convert a result of the processing into a format including an index value, category information, and an explanatory text, generate display control information for presenting the index value, the category information, and the explanatory text as a list screen and a chart screen for the user, and transmit the display control information to the terminal device so as to visually present the list screen and the chart screen in a dashboard format.

### Application Example 1

### Supplementary 1

A system comprising a processor,
wherein the processor is configured to
provide, by generating and transmitting screen information to a user terminal, an interactive interface including a character input unit, a selection input unit, and an evaluation input unit on the user terminal so as to acquire evaluation information and request information from a user,
store the acquired evaluation information and request information in a storage unit, perform preprocessing including character string normalization on the acquired evaluation information and request information, and analyze the preprocessed evaluation information and request information by using a natural language processing algorithm to segment the preprocessed evaluation information and request information into units of morphemes or phrases and convert the segmented information into structured data including an emotion value, an evaluation index, and classification information,
aggregate a plurality of pieces of the structured data, and generate, on the basis of an aggregation result, context information indicating a target domain, an occurrence tendency, and constraint conditions, thereby generating aggregated information related to the evaluation information and the request information,
automatically generate, on the basis of an analysis result including the structured data and the context information and the emotion value, a prompt sentence that explicitly indicates a generation target of improvement measures, types of required measures, and implementation conditions, in accordance with a template, thereby generating a prompt sentence to be input to a generative AI model,
transmit input information including the prompt sentence and the analysis result to the generative AI model, and acquire, from the generative AI model, a generation result as text data including a plurality of improvement measures and including a content description for each of the plurality of improvement measures, thereby causing the generative AI model to generate the improvement measures,
divide the generation result into a plurality of improvement measure items, assign classification information and priority information to each of the plurality of improvement measure items, generate structured improvement data including the plurality of improvement measure items, and transmit the structured improvement data to the user terminal, thereby presenting the improvement measures, and
acquire, from the user terminal, approval information, disapproval information, or additional evaluation information from the user with respect to the structured improvement data, reanalyze the additional evaluation information by the natural language processing algorithm to update the context information, regenerate the prompt sentence on the basis of the updated context information and the approval information or the disapproval information, and re-input the regenerated prompt sentence to the generative AI model, thereby repeatedly executing a proposal process of the improvement measures.

### Supplementary 2

The system according to supplementary 1,
wherein the processor is configured to
aggregate the evaluation information and the request information for each of a product domain, a service domain, or a customer segment on the basis of the structured data and the context information, and append an explanatory sentence including an aggregation result to the prompt sentence so as to guide the generative AI model to output a plurality of measure candidates constituting a sales policy, a service policy, or an operation policy.

### Supplementary 3

The system according to supplementary 1,
wherein the processor is configured to
store the structured improvement data acquired from the generative AI model in association with the structured data, generate screen information for presenting, to the user terminal, visualization information including, for each improvement measure item included in the structured improvement data, the classification information, the priority information, and a related emotion value as index values, graphical displays, or list displays, and transmit, to the user terminal, a prompt sentence for causing the generative AI model to generate the screen information, thereby visually presenting analysis results and the improvement measures by the generative AI model in a dashboard format.

### Example 2

### Supplementary 1

A system comprising a processor,
wherein the processor is configured to
receive, via a communication terminal, opinion information and request information from a user and store the opinion information and the request information as structured information in a storage unit,
execute, by using a natural language processing program, preprocessing including character string normalization processing, unnecessary symbol removal processing, and function word removal processing on the opinion information and the request information stored in the storage unit to generate analysis text data,
execute, by using a sentiment classification process based on a deep learning algorithm, processing on the analysis text data as input to calculate, for each piece of text data, a sentiment label including at least one of positive, negative, and neutral, and confidence information corresponding to the sentiment label, and to store the sentiment label and the confidence information in association with the opinion information and the request information in the storage unit,
aggregate, based on the sentiment label and the confidence information stored in the storage unit, statistical information on at least one of a product unit, a time unit, and a user attribute unit to generate sentiment tendency information and issue extraction information,
automatically generate prompt data defining a prompt sentence to be input to a generative artificial intelligence model, the prompt data being generated based on analysis result information including at least a part of the sentiment tendency information, the issue extraction information, and the opinion information and the request information,
transmit the prompt data to the generative artificial intelligence model and acquire, from the generative artificial intelligence model, response information including improvement measure information and marketing measure information derived based on the analysis result information and the sentiment label,
reconstruct report information by associating the acquired response information with the statistical information, generate a visualization screen based on the report information, and output display control information for causing the visualization screen to be displayed in a dashboard format.

### Supplementary 2

The system according to supplementary 1,
wherein the processor is configured to
generate the prompt data so as to include classification condition information for grouping a plurality of pieces of the opinion information and the request information and major issue information automatically extracted based on the statistical information, and to cause the generative artificial intelligence model to divide the plurality of pieces of the opinion information and the request information into logical issue groups in accordance with the classification condition information and to generate, for each of the issue groups, the improvement measure information and the marketing measure information.

### Supplementary 3

The system according to supplementary 1,
wherein the processor is configured to
include, in the display control information, operation information that enables execution state information to be assigned to each item of the improvement measure information and the marketing measure information acquired from the generative artificial intelligence model, accept, on the visualization screen in the dashboard format, an update operation of the execution state information by a user, and store updated execution state information in the storage unit in association with the report information.

### Application Example 2

### Supplementary 1

A system comprising a processor,
wherein the processor is configured to
perform input/output processing to obtain evaluation information from a user,
store the obtained evaluation information in a storage device and preprocess the evaluation information by natural language processing, including at least word segmentation, removal of non-informative terms, and normalization of word forms,
execute an emotion estimation model on the preprocessed evaluation information to perform emotion classification processing and calculate, for each piece of evaluation information, a plurality of emotion labels and a confidence value for each emotion label,
extract, based on the emotion labels, positive evaluation elements and improvement request elements for each target item or target service, aggregate the elements, and store the aggregated elements as index information in association with the target item or the target service in the storage device,
automatically generate a prompt sentence for input to a generative AI model based on the index information and the emotion labels contained in analysis results, and embed the analysis results and operation conditions into the prompt sentence so as to guide the generative AI model to generate optimized improvement measures or action measures, store, in the storage device, the improvement measures or the action measures output from the generative AI model and provide the improvement measures or the action measures as visualization information to the input/output processing, and
obtain additional evaluation information or constraint condition information from the user with respect to the improvement measures or the action measures, and execute loop processing in which the additional evaluation information or the constraint condition information is reflected in the prompt sentence and the generative AI model is caused to regenerate or adjust the measures.

### Supplementary 2

The system according to supplementary 1,
wherein the processor is configured to
use the analysis results including the emotion labels and aggregation results of the positive evaluation elements and the improvement request elements to automatically generate the prompt sentence, and present, to the generative AI model, the prompt sentence in which sales measures, advertising measures, or operation measures related to the target item or the target service are associated with time-series data and attribute data, thereby guiding the generative AI model to automatically determine and propose related market measures.

### Supplementary 3

The system according to supplementary 1,
wherein the processor is configured to
generate, as the visualization information, structured data in which the improvement measures or the action measures output from the generative AI model are associated with the emotion labels and the index information, and generate display data for forming a dashboard-type screen on a display device based on the structured data so as to visually present marketing measures to the user.

What is claimed is:

1. A system comprising:
circuitry configured to:
receive, via a communication interface coupled to a packet-switched network, text information and selection information from a terminal device via an interactive display screen, structure the received information, and store the structured information in a storage device;
apply natural language processing techniques and input the structured information as a prompt sentence to a generative AI model to extract sentiment from the text information and generate a result including proposed improvement measures and actions based on the analysis result and the extracted sentiment; and
transmit the result to the terminal device via the communication interface.

2. The system according to claim 1, wherein the circuitry is configured to generate, using a markup language and a control language, an interactive display screen for receiving opinions and selection information from a user, and transmit the interactive display screen to the terminal device via the communication interface.

3. The system according to claim 2, wherein the circuitry is configured to receive text information and selection information input on the interactive display screen by event detection processing, and structure the received text information and selection information for storage in the storage device.

4. The system according to claim 3, wherein the circuitry is configured to generate a prompt sentence incorporating the structured text information, the selection information, and an instruction for the generative AI model to classify the sentiment of the text information and propose improvement measures based on the classification.

5. The system according to claim 4, wherein the circuitry is configured to receive from the generative AI model a result including sentiment classification, proposed improvement measures, and associated action items, and transmit the result to the terminal device for display.

6. The system according to claim 1, wherein the circuitry is configured to generate a prompt sentence instructing the generative AI model to determine related optimization strategies from the contents of the analyzed text information and selection information, and incorporate the determined strategies into the transmitted result.

7. The system according to claim 6, wherein the circuitry is configured to generate a prompt sentence instructing the generative AI model to generate an output strategy based on the analysis result and the extracted sentiment, and format the output strategy for visual display in a dashboard format on the terminal device.

8. The system according to claim 1, wherein the circuitry is configured to aggregate structured information from a plurality of terminal devices received via the communication interface, and generate a prompt sentence incorporating aggregated information for input to the generative AI model to produce organization-level analysis results.

9. The system according to claim 8, wherein the circuitry is configured to segment the aggregated information by topic category extracted from the text information, generate separate prompt sentences for each segment, and obtain topic-specific improvement measures from the generative AI model.

10. The system according to claim 1, wherein the circuitry is configured to receive follow-up text information from the terminal device after initial improvement measures are presented, incorporate the follow-up text information into a new prompt sentence for the generative AI model, and obtain updated improvement measures.

11. The system according to claim 10, wherein the circuitry is configured to maintain a multi-turn dialogue record in the storage device, and incorporate the dialogue history into subsequent prompt sentences to provide contextually consistent improvement suggestions.

12. The system according to claim 1, wherein the circuitry is configured to extract numerical and categorical response patterns from the selection information, and incorporate these patterns as structured features into the prompt sentence for the generative AI model to improve sentiment accuracy.

13. The system according to claim 12, wherein the circuitry is configured to combine the extracted numerical patterns with the text-based sentiment extracted by the generative AI model to generate a composite sentiment score for each item of text information.

14. The system according to claim 1, wherein the circuitry is configured to track changes in sentiment extracted from text information received from the terminal device over time, detect trends or anomalies in the tracked sentiment, and incorporate the trend data into prompt sentences for the generative AI model.

15. The system according to claim 14, wherein the circuitry is configured to generate a time-series visualization of sentiment trends and transmit the visualization as display data to the terminal device via the communication interface.

16. The system according to claim 1, wherein the circuitry is configured to receive, from the terminal device, a request to view improvement measures or actions associated with a specific sentiment category, generate a prompt sentence for the generative AI model to retrieve and elaborate on the relevant improvement measures, and transmit the result to the terminal device.

17. The system according to claim 16, wherein the circuitry is configured to store records of improvement measures and actions in the storage device in association with sentiment category identifiers, and retrieve stored records to accelerate generation of responses to subsequent requests.

18. A system comprising:
circuitry configured to:
receive, via a communication interface coupled to a packet-switched network, text information and selection information from a terminal device, structure the received information, and store the structured information in a storage device;
apply natural language processing and input a prompt sentence incorporating the structured information to a generative AI model to extract sentiment and generate proposed improvement measures and actions based on the analysis result;
generate a prompt sentence instructing the generative AI model to generate an output strategy based on the analysis result and the extracted sentiment; and
transmit the improvement measures, actions, and output strategy to the terminal device via the communication interface for display in a dashboard format.

19. The system according to claim 18, wherein the circuitry is configured to aggregate structured information from a plurality of terminal devices received via the communication interface, generate prompt sentences incorporating the aggregated information, and obtain organization-level analysis results from the generative AI model for transmission to designated terminal devices.

20. A method comprising:
receiving, via a communication interface coupled to a packet-switched network, text information and selection information from a terminal device via an interactive display screen, structuring the received information, and storing the structured information in a storage device;
applying natural language processing techniques and inputting the structured information as a prompt sentence to a generative AI model to extract sentiment and generate proposed improvement measures and actions based on the analysis result and the extracted sentiment; and
transmitting the result to the terminal device via the communication interface.
